(19) United States
(12) Patent Application Publication
(10) Pub. No.: US 2023/0152757 A1
(43) Pub. Date: May 18, 2023

(54) BUILDING DATA PLATFORM WITH DIGITAL TWIN BASED FAULT DETECTION AND DIAGNOSTICS

(71) Applicant: Johnson Controls Tyco IP Holdings LLP, Milwaukee, WI (US)

(72) Inventors: Young M. Lee, Old Westbury, NY (US); Rajiv Ramanasankaran, San Jose, CA (US)

(21) Appl. No.: 17/737,873

(22) Filed: May 5, 2022

Related U.S. Application Data
(63) Continuation-in-part of application No. 17/540,725, filed on Dec. 2, 2021.
Application No. 17/540,725 is a continuation-in-part of application No. 17/529,118, filed on Nov. 17, 2021.

(51) Int. Cl. G05B 13/04; G05B 13/02; G05B 23/02

(52) U.S. Cl. CPC G05B 13/04; G05B 13/0265; G05B 23/0254

(57) ABSTRACT

Systems and methods of managing a building are disclosed. In some embodiments, a method includes receiving, by a processing circuit, an indication to execute a digital twin, the digital twin including one or more fault detection or diagnostics functions and a virtual representation of a piece of equipment, the virtual representation including one or more entities of a building and relationships between the entities of the building, executing the digital twin based on the virtual representation of the piece of building equipment to generate an indication of a fault or a diagnosis of the fault for the one or more pieces of building equipment, and storing an indication of the fault or a diagnosis of the fault, or a link to the fault or the diagnosis of the fault, in the virtual representation of the piece of equipment.

### CROSS-REFERENCE TO RELATED PATENT APPLICATIONS

The present application is a continuation-in-part of U.S. patent application Ser. No. 17/540,725, filed Dec. 2, 2021, which is a continuation-in-part of U.S. patent application Ser. No. 17/529,118, filed Nov. 17, 2021, the contents of each of which are incorporated herein by reference in their entirety.

### BACKGROUND

This application relates generally to a building system of a building. This application relates more particularly to systems for tuning fault detection of the building system.

A building management system (BMS) is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. Specifically, the present disclosure relates to a BMS with an equipment monitoring system to accurately determine whether the BMS is experiencing a fault.

### SUMMARY

One aspect is a building system of a building, the building system including one or more storage media having instructions stored thereon that, when executed by one or more processors, cause the one or more processors to: store a digital twin on the one or more storage media, the digital twin including one or more fault detection or diagnostics functions and a virtual representation of a piece of equipment, the virtual representation including one or more entities of a building and relationships between the entities of the building. The one or more fault detection or diagnostic functions operate on the virtual representation of the piece of equipment to perform fault detection or diagnostics. In some embodiments, the instructions further cause the one or more processors to execute the digital twin based on the virtual representation of the piece of building equipment to generate an indication of a fault or a diagnosis of the fault for the one or more pieces of building equipment, and store an indication of the fault or a diagnosis of the fault, or a link to the fault or the diagnosis of the fault, in the virtual representation of the piece of equipment.

In some embodiments, the virtual representation of the one or more pieces of building equipment includes a building graph including a plurality of nodes representing a plurality of entities of the building and a plurality of edges between the plurality of nodes representing relationships between the plurality of entities of the building.

In some embodiments, the one or more fault detection or diagnostics functions include a fault rule including a threshold, and the threshold being met indicates the fault or a diagnosis for the fault.

In some embodiments, the instructions further cause the one or more processors to receive a state of the building equipment, assess, using a machine learning model, whether the determination of whether the building equipment has the fault is a false positive or a false negative based on the state and the threshold, determine a new threshold based on the assessment of the machine learning model, and replace the threshold with the new threshold to make subsequent determinations of whether the building equipment or other building equipment has a fault.

In some embodiments, the new threshold reduces a number of false positives a number of false negatives.

In some embodiments, the instructions further cause the one or more processors to accumulate training data for the machine learning model using the state and the threshold as inputs and labels of false positive or false negative as outputs.

In some embodiments, the fault rule includes a condition portion including a comparison of the state to the threshold and an action portion including a determination that the building equipment is faulty when the condition is satisfied or not faulty when the condition is not satisfied.

In some embodiments, the instructions further cause the one or more processors to perturb the building equipment with multiple values of the threshold to provide additional data for the machine learning model.

In some embodiments, the machine learning model includes a first machine learning model for predicting a false negative and a second machine learning model for predicting a false positive.

In some embodiments, the first machine learning model is configured to accurately predict false positives at different values of state and threshold, and the instructions further cause the one or more processors to retrain the first machine learning model.

In some embodiments, the second machine learning model is configured predict false negatives at different values of state and threshold, and the instructions further cause the one or more processors to retrain the second machine learning model.

In some embodiments, the instructions further cause the one or more processors to receive an indication to receive an indication that a fault has been detected in the digital twin and execute a second digital twin, the second digital twin including one or more fault detection or diagnostics functions and a second virtual representation of a second piece of equipment, the second virtual representation including one or more second entities of a building and relationships between at least one of the second entities of the building and at least one of the entities of the building. The one or more fault detection or diagnostic functions of the second digital twin operate on the second virtual representation of the piece of equipment to perform fault detection or diagnostics based on a determination of the fault detected in the digital twin.

In some embodiments, the instructions further cause the one or more processors to receive an indication to execute a fault detection and diagnostics (FDD) agent including one or more machine learning models for determining a new threshold in a fault rule for determining whether the building equipment has a fault, and providing training data to the machine learning model. The training data includes a plurality of states and a plurality of thresholds of the fault rule as inputs and feedbacks of false positive and false negative of the fault rule as outputs.

Another aspect is a method including receiving, by a processing circuit, an indication to execute a digital twin, the digital twin including one or more fault detection or diagnostics functions and a virtual representation of a piece of equipment, the virtual representation including one or more entities of a building and relationships between the entities of the building. The one or more fault detection or diagnostic functions operate on the virtual representation of the piece of equipment to perform fault detection or diagnostics. The method further includes executing, by the processing circuit, the digital twin based on the virtual representation of the piece of building equipment to generate an indication of a fault or a diagnosis of the fault for the one or more pieces of building equipment, and storing, by the processing circuit, an indication of the fault or a diagnosis of the fault, or a link to the fault or the diagnosis of the fault, in the virtual representation of the piece of equipment.

In some embodiments, the virtual representation of the one or more pieces of building equipment includes a building graph including a plurality of nodes representing a plurality of entities of the building and a plurality of edges between the plurality of nodes representing relationships between the plurality of entities of the building, and the one or more fault detection or diagnostics functions include a fault rule including a threshold. The threshold being met indicates the fault or a diagnosis for the fault.

In some embodiments, the instructions further cause the one or more processors to receiving, by the processing circuit, a state of the building equipment, assessing, by the processing circuit using a machine learning model, whether the determination of whether the building equipment has the fault is a false positive or a false negative based on the state and the threshold, determining, by the processing circuit, a new threshold based on the assessment of the machine learning model, and replacing, by the processing circuit, the threshold with the new threshold to make subsequent determinations of whether the building equipment or other building equipment has a fault.

In some embodiments, the method further includes accumulating, by the processing circuit, training data for the machine learning model using the state and the threshold as inputs and labels of false positive or false negative as outputs. The new threshold reduces a number of false positives a number of false negatives.

Another aspect is a non-transitory computer-readable storage medium having instructions stored thereon that, when executed by one or more processors, cause the one or more processors to receive an indication to execute a digital twin, the digital twin including one or more fault detection or diagnostics functions and a virtual representation of a piece of equipment, the virtual representation including one or more entities of a building and relationships between the entities of the building. The one or more fault detection or diagnostic functions operate on the virtual representation of the piece of equipment to perform fault detection or diagnostics. The instructions further cause the one or more processors to execute the digital twin based on the virtual representation of the piece of building equipment to generate an indication of a fault or a diagnosis of the fault for the one or more pieces of building equipment, and store an indication of the fault or a diagnosis of the fault, or a link to the fault or the diagnosis of the fault, in the virtual representation of the piece of equipment.

In some embodiments, the virtual representation of the one or more pieces of building equipment includes a building graph including a plurality of nodes representing a plurality of entities of the building and a plurality of edges between the plurality of nodes representing relationships between the plurality of entities of the building, and the one or more fault detection or diagnostics functions include a fault rule including a threshold. The threshold being met indicates the fault or a diagnosis for the fault.

In some embodiments, the instructions further cause the one or more processors to receive a state of the building equipment, assess, using a machine learning model, whether the determination of whether the building equipment has the fault is a false positive or a false negative based on the state and the threshold, determine a new threshold based on the assessment of the machine learning model, and replace the threshold with the new threshold to make subsequent determinations of whether the building equipment or other building equipment has a fault.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a building data platform including an edge platform, a cloud platform, and a twin manager, according to an exemplary embodiment.

FIG. 2 is a graph projection of the twin manager of FIG. 1 including application programming interface (API) data, capability data, policy data, and services, according to an exemplary embodiment.

FIG. 3 is another graph projection of the twin manager of FIG. 1 including application programming interface (API) data, capability data, policy data, and services, according to an exemplary embodiment.

FIG. 4 is a graph projection of the twin manager of FIG. 1 including equipment and capability data for the equipment, according to an exemplary embodiment.

FIG. 5 is a block diagram of a system for managing a digital twin where an artificial intelligence agent can be executed to infer information for an entity of a graph, according to an exemplary embodiment.

FIG. 6 is a flow diagram of a process for executing an artificial intelligence agent to infer and/or predict information, according to an exemplary embodiment.

FIG. 7 is a diagram of a digital twin including a connector and a database, according to an exemplary embodiment.

FIG. 8 is a block diagram of a digital twin including triggers, connectors, actions, and a graph, according to an exemplary embodiment.

FIG. 9 is a block diagram of a people counter digital twin, an HVAC digital twin, and a facility manager digital twin that have triggers and actions that are interconnected, according to an exemplary embodiment.

FIG. 10 is a block diagram of an employee digital twin, a calendar digital twin, a meeting room digital twin, and a cafeteria digital twin that have triggers and actions that are interconnected, according to an exemplary embodiment.

FIG. 11 is a flow diagram an agent of a digital twin executing a trigger rule and an action rule, according to an exemplary embodiment.

FIG. 12 is a block diagram of a trigger rule of a thermostat digital twin where parameters of the trigger rule is trained, according to an exemplary embodiment.

FIG. 13 is a flow diagram of a process for identifying values for the parameters of the trigger rule of FIG. 12, according to an exemplary embodiment.

FIG. 14 is a minimization that can be performed to identify the values for the parameters of the trigger rule of FIGS. 12-13, according to an exemplary embodiment.

FIG. 15 is a block diagram of an action rule of a thermostat digital twin where parameters of the action rule is trained, according to an exemplary embodiment.

FIG. 16 is lists of states of a zone and of an air handler unit that can be used to train the parameters of the trigger rule and the action rule of the thermostat digital twins of FIGS. 12-15, according to an exemplary embodiment.

FIG. 17 is a block diagram of a trigger rule of a chemical reactor digital twin where parameters of the trigger rule are trained, according to an exemplary embodiment.

FIG. 18 is a flow diagram of a process for identifying values for the parameters of the trigger rule of FIG. 17, according to an exemplary embodiment.

FIG. 19 is a minimization that can be performed to identify the values for the parameters of the trigger rule of FIGS. 17-18, according to an exemplary embodiment.

FIG. 20 is a block diagram of an action rule of a chemical reactor digital twin where parameters of the action rule are trained, according to an exemplary embodiment.

FIG. 21 is lists of states of a reactor and a feed of a reactor that can be included in the trigger rule and the action rule of FIGS. 12-15, according to an exemplary embodiment.

FIG. 22 is a block diagram of triggers and actions that can be constructed and learned for a digital twin, according to an exemplary embodiment.

FIG. 23 is a flow diagram of a process for constructing triggers and actions for a digital twin, according to an exemplary embodiment.

FIG. 24 is a block diagram of a system including a fault detection system, according to some embodiments.

FIG. 25 is a system of digital twins that are interconnected, according to some embodiments.

FIG. 26 is a block diagram of a system to find an optimal threshold of a fault detection and diagnosis rule, according to an exemplary embodiment.

FIG. 27 is a flow diagram of a process for identifying values for the parameters of the threshold of FIG. 26, according to an exemplary embodiment.

FIG. 28 is an optimization algorithm that can be performed to identify the optimal threshold for the fault detection and diagnosis rule of FIGS. 26 and 27, according to an exemplary embodiment.

FIG. 29 is a flow diagram of a process for calculating the optimal threshold, according to an exemplary embodiment.

### DETAILED DESCRIPTION

### Overview

Referring generally to the FIGURES, systems and methods for autonomous fault detection and diagnosis rule threshold tuning are shown, according to various exemplary embodiments. One method of detecting faults in buildings and their equipment is using rules to detect and diagnose faults. For example, when a building controller detects that a rule is satisfied, the building controller may determine that a subsystem pertaining to or associated with the rule has or may have a fault that should be adjusted and/or fixed.

A common technique of detecting faults in building equipment is using rules within building management systems (BMS). There may be one or more rules pertaining any particular building equipment (e.g., air handling unit, lighting equipment, etc.). Ideally the BMS will always correctly determine whether the building equipment is experiencing a fault or not. However, it is possible that the BMS determines that a fault exists even when the building equipment is operating normally (false positive), or that the BMS determines that a fault does not exist even when the building equipment does actually have a fault (false negative). When a fault is detected, the building manager may be notified by an alarm so that the building equipment may be inspected and/or a work order may be generated for a technician to fix the building equipment. This failure in accurate determination can lead to equipment failures, occupant discomfort and/or safety concerns, excessive costs, and waste.

Rules often include a condition portion and an action portion. When the condition portion is satisfied, the action portion may be executed. For example, there may be a rule for an air handling unit (AHU) that states, in the condition portion, that the supply air temperature is below a first threshold temperature and the fan speed of the AHU is greater than a second threshold rotations per minute (rpm). The rule may have an action portion that states that the AHU is at fault. In this rule, the condition portion is satisfied if both the supply air temperature is below the first threshold and the fan speed is greater than the second threshold, and the system can receive a determination that the AHU is faulty.

Rules are not always set for every condition and for every equipment. Accordingly, the rules may need to be adjust depending on operating conditions, equipment, occupants, etc. Further, the rules may need to be adjust because the equipment may degrade over time. If a threshold is too small, normal variation in operating conditions may result in false alarms, and if the threshold is too great, only a few extremely severe faults may be detected. Furthermore, manually adjusting or tuning thresholds is very difficult because of inaccuracies or overcompensation, which can lead to similar or different problems. Accordingly, there is a need to automatically tune the thresholds in rules.

A digital twin can be a virtual representation of a building and/or an entity of the building (e.g., space, piece of equipment, occupant, etc.). A virtual representation of a building could be a graph data structure. The virtual representation could be a graphic model, e.g., a building information model (BIM). The virtual representation of the building could be a hierarchical model, in some embodiments. Furthermore, the digital twin can represent a service performed in a building, e.g., facility management, equipment maintenance, etc.

In some embodiments, the digital twin can include an information data store and a connector. The information data store can store the information describing the entity that the digital twin operates for (e.g., attributes of the entity, measurements associated with the entity, control points or commands of the entity, etc.). In some embodiments, the data store can be a graph including various nodes and edges. The connector can be a software component that provides telemetry from the entity (e.g., physical device) to the information store. In some embodiments, the attributes of the digital can be kept in sync with the real device (e.g., building or an entity connected to or part of the building) via the connectors. For example, one or more of the measurements and sensed data and other attributes that can include individual data points, aggregated states, or calculated states can be synced between the digital twin and the real device. Furthermore, the digital twin can include artificial intelligence (AI), e.g., an AI agent. The AI can be one or more machine learning algorithms and/or models that operate based on information of the information data store and outputs information.

In some embodiments, the AI agent for the digital twin can call an AI service to determine inferences about potential future events and/or predict future data values. In some embodiments, the inferences are potential future states. In some embodiments, the inferences predict a timeseries of a data point into the future. The inferences could be inferred indoor temperature for an hour, inferred future air quality from 15 minute air quality readings, etc. In some embodiments, the digital twin can store inferred information in a graph data store as a node in the graph data store related to an entity that the digital twin represents. In some embodiments, the digital twin, or other digital twins, can operate against the inferred data, e.g., operate to construct and implement control algorithms for operating equipment of a building based on predicted future data points of the building. The inferences may be stored as an attribute of the digital twin and may not be present in the real device itself or a memory connected to the real device.

Furthermore, the AI agent can include various triggers and/or actions, conditions that define when and how command and control occurs for an entity. The triggers and actions can be rule based conditional and operational statements that are associated with a specific digital twin, e.g., are stored and executed by an AI agent of the digital twin. In some embodiments, the building system can identify actions and/or triggers (or parameters for the actions and/or triggers) through machine learning algorithms. In some embodiments, the building system can evaluate the conditions/context of the graph and determine and/or modify the triggers and actions of a digital twin.

In some embodiments, a building system can automatically tune the thresholds of rules described herein. In some embodiments, some data is collected concerning the rules and whether the rules resulted in false positives or false negatives. The data can include the state of the building equipment, the threshold of the rule, and a determination of whether the rule resulted in a false positive or a false negative. This data can be provided as training data for a machine learning model or multiple models that can be trained to predict when a false positive or a false negative is going to occur based on the state and threshold. Once the model is trained, an optimization technique can be used to determine the optimal threshold level that minimizes the numbers of false positives and false negatives. The optimal threshold can then replace the existing threshold so that false positives and false negatives are minimized.

Building Data Platform with Digital Twins

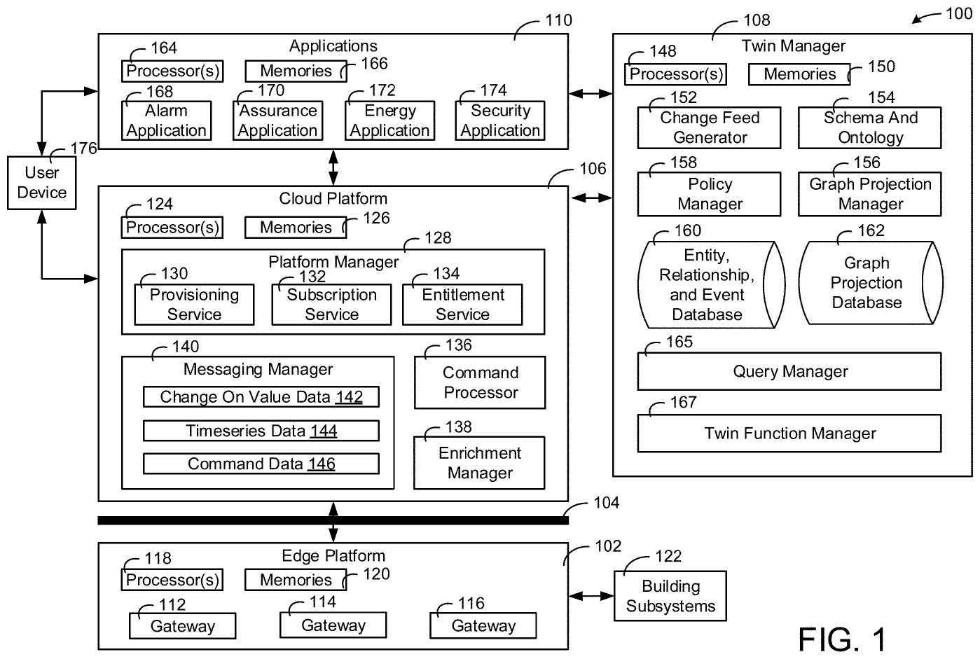

Referring now to FIG. 1, a building data platform 100 including an edge platform 102, a cloud platform 106, and a twin manager 108 are shown, according to an exemplary embodiment. The edge platform 102, the cloud platform 106, and the twin manager 108 can each be separate services deployed on the same or different computing systems. In some embodiments, the cloud platform 106 and the twin manager 108 are implemented in off-premises computing systems, e.g., outside a building. The edge platform 102 can be implemented on-premises, e.g., within the building. However, any combination of on-premises and off-premises components of the building data platform 100 can be implemented.

The building data platform 100 includes applications 110. The applications 110 can be various applications that operate to manage the building subsystems 122. The applications 110 can be remote or on-premises applications (or a hybrid of both) that run on various computing systems. The applications 110 can include an alarm application 168 configured to manage alarms for the building subsystems 122. The applications 110 include an assurance application 170 that implements assurance services for the building subsystems 122. In some embodiments, the applications 110 include an energy application 172 configured to manage the energy usage of the building subsystems 122. The applications 110 include a security application 174 configured to manage security systems of the building.

In some embodiments, the applications 110 and/or the cloud platform 106 interacts with a user device 176. In some embodiments, a component or an entire application of the applications 110 runs on the user device 176. The user device 176 may be a laptop computer, a desktop computer, a smartphone, a tablet, and/or any other device with an input interface (e.g., touch screen, mouse, keyboard, etc.) and an output interface (e.g., a speaker, a display, etc.).

The applications 110, the twin manager 108, the cloud platform 106, and the edge platform 102 can be implemented on one or more computing systems, e.g., on processors and/or memory devices. For example, the edge platform 102 includes processor(s) 118 and memories 120, the cloud platform 106 includes processor(s) 124 and memories 126, the applications 110 include processor(s) 164 and memories 166, and the twin manager 108 includes processor(s) 148 and memories 150.

The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CD-ROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

The edge platform 102 can be configured to provide connection to the building subsystems 122. The edge platform 102 can receive messages from the building subsystems 122 and/or deliver messages to the building subsystems 122. The edge platform 102 includes one or multiple gateways, e.g., the gateways 112-116. The gateways 112-116 can act as a gateway between the cloud platform 106 and the building subsystems 122. The gateways 112-116 can be the gateways described in U.S. patent application Ser. No. 17/127,303 filed Dec. 18, 2020, the entirety of which is incorporated by reference herein. In some embodiments, the applications 110 can be deployed on the edge platform 102. In some embodiments, lower latency in management of the building subsystems 122 can be realized.

The edge platform 102 can be connected to the cloud platform 106 via a network 104. The network 104 can communicatively couple the devices and systems of building data platform 100. In some embodiments, the network 104 is at least one of and/or a combination of a Wi-Fi network, a wired Ethernet network, a ZigBee network, a Bluetooth network, and/or any other wireless network. The network 104 may be a local area network or a wide area network (e.g., the Internet, a building WAN, etc.) and may use a variety of communications protocols (e.g., BACnet, IP, LON, etc.). The network 104 may include routers, modems, servers, cell towers, satellites, and/or network switches. The network 104 may be a combination of wired and wireless networks.

The cloud platform 106 can be configured to facilitate communication and routing of messages between the applications 110, the twin manager 108, the edge platform 102, and/or any other system. The cloud platform 106 can include a platform manager 128, a messaging manager 140, a command processor 136, and an enrichment manager 138. In some embodiments, the cloud platform 106 can facilitate messaging between the building data platform 100 via the network 104.

The messaging manager 140 can be configured to operate as a transport service that controls communication with the building subsystems 122 and/or any other system, e.g., managing commands to devices (C2D), commands to connectors (C2C) for external systems, commands from the device to the cloud (D2C), and/or notifications. The messaging manager 140 can receive different types of data from the applications 110, the twin manager 108, and/or the edge platform 102. The messaging manager 140 can receive change on value data 142, e.g., data that indicates that a value of a point has changed. The messaging manager 140 can receive timeseries data 144, e.g., a time correlated series of data entries each associated with a particular time stamp. Furthermore, the messaging manager 140 can receive command data 146. All of the messages handled by the cloud platform 106 can be handled as an event, e.g., the data 142-146 can each be packaged as an event with a data value occurring at a particular time (e.g., a temperature measurement made at a particular time).

The cloud platform 106 includes a command processor 136. The command processor 136 can be configured to receive commands to perform an action from the applications 110, the building subsystems 122, the user device 176, etc. The command processor 136 can manage the commands, determine whether the commanding system is authorized to perform the particular commands, and communicate the commands to the commanded system, e.g., the building subsystems 122 and/or the applications 110. The commands could be a command to change an operational setting that control environmental conditions of a building, a command to run analytics, etc.

The cloud platform 106 includes an enrichment manager 138. The enrichment manager 138 can be configured to enrich the events received by the messaging manager 140. The enrichment manager 138 can be configured to add contextual information to the events. The enrichment manager 138 can communicate with the twin manager 108 to retrieve the contextual information. In some embodiments, the contextual information is an indication of information related to the event. For example, if the event is a timeseries temperature measurement of a thermostat, contextual information such as the location of the thermostat (e.g., what room), the equipment controlled by the thermostat (e.g., what variable air volume (VAV)), etc. can be added to the event. In some embodiments, when a consuming application, e.g., one of the applications 110 receives the event, the consuming application can operate based on the data of the event, the temperature measurement, and also the contextual information of the event.

The enrichment manager 138 can solve a problem that when a device produces a significant amount of information, the information may contain simple data without context. An example might include the data generated when a user scans a badge at a badge scanner of the building subsystems 122. This physical event can generate an output event including such information as “DeviceBadgeScannerID,” “BadgeID,” and/or “Date/Time.” However, if a system sends this data to a consuming application, e.g., Consumer A and a Consumer B, each customer may need to call the building data platform knowledge service to query information with queries such as, “What space, build, floor is that badge scanner in?” or “What user is associated with that badge?”

By performing enrichment on the data feed, a system can be able to perform inferences on the data. A result of the enrichment may be transformation of the message “DeviceBadgeScannerId, BadgeId, Date/Time,” to “Region, Building, Floor, Asset, DeviceId, BadgeId, UserName, EmployeeId, Date/Time Scanned.” This can be a significant optimization, as a system can reduce the number of calls by 1/n, where n is the number of consumers of this data feed.

By using this enrichment, a system can also have the ability to filter out undesired events. If there are 100 building in a campus that receive 100,000 events per building each hour, but only 1 building is actually commissioned, only 1/10 of the events are enriched. By looking at what events are enriched and what events are not enriched, a system can do traffic shaping of forwarding of these events to reduce the cost of forwarding events that no consuming application wants or reads.

An example of an event received by the enrichment manager 138 may be:

```
{
  “id”: “someguid”,
  “eventType”: “Device_Heartbeat”,
  “eventTime”: “2018-01-27T00:00:00+00:00”
  “eventValue”: 1,
  “deviceID”: “someguid”
}
```

An example of an enriched event generated by the enrichment manager 138 may be:

```
{
  “id”: “someguid”,
  “eventType”: “Device_Heartbeat”,
  “eventTime”: “2018-01-27T00:00:00+00:00”
  “eventValue”: 1,
  “deviceID”: “someguid”,
  “buildingName”: “Building-48”,
  “buildingID”: “SomeGuid”,
  “panelID”: “SomeGuid”,
  “panelName”: “Building-48-Panel-13”
  “cityID”: 371,
  “cityName”: “Milwaukee”,
  “stateID”: 48,
  “stateName”: “Wisconsin (WI)”,
  “country ID”: 1,
  “countryName”: “United States”
}
```

By receiving enriched events, an application of the applications 110 can populate and/or filter what events are associated with what areas. Furthermore, user interface generating applications can generate user interfaces that include the contextual information based on the enriched events.

The cloud platform 106 includes a platform manager 128. The platform manager 128 can be configured to manage the users and/or subscriptions of the cloud platform 106. For example, what subscribing building, user, and/or tenant utilize the cloud platform 106. The platform manager 128 includes a provisioning service 130 configured to provision the cloud platform 106, the edge platform 102, and the twin manager 108. The platform manager 128 includes a subscription service 132 configured to manage a subscription of the building, user, and/or tenant while the entitlement service 134 can track entitlements of the buildings, users, and/or tenants.

The twin manager 108 can be configured to manage and maintain a digital twin. The digital twin can be a digital representation of the physical environment, e.g., a building. The twin manager 108 can include a change feed generator 152, a schema and ontology 154, a projection manager 156, a policy manager 158, an entity, relationship, and event database 160, and a graph projection database 162.

The graph projection manager 156 can be configured to construct graph projections and store the graph projections in the graph projection database 162. Entities, relationships, and events can be stored in the database 160. The graph projection manager 156 can retrieve entities, relationships, and/or events from the database 160 and construct a graph projection based on the retrieved entities, relationships and/or events. In some embodiments, the database 160 includes an entity-relationship collection for multiple subscriptions.

In some embodiments, the graph projection manager 156 generates a graph projection for a particular user, application, subscription, and/or system. In some embodiments, the graph projection can be generated based on policies for the particular user, application, and/or system in addition to an ontology specific for that user, application, and/or system. In some embodiments, an entity could request a graph projection and the graph projection manager 156 can be configured to generate the graph projection for the entity based on policies and an ontology specific to the entity. The policies can indicate what entities, relationships, and/or events the entity has access to. The ontology can indicate what types of relationships between entities the requesting entity expects to see, e.g., floors within a building, devices within a floor, etc. Another requesting entity may have an ontology to see devices within a building and applications for the devices within the graph.

The graph projections generated by the graph projection manager 156 and stored in the graph projection database 162 can be a knowledge graph and is an integration point. For example, the graph projections can represent floor plans and systems associated with each floor. Furthermore, the graph projections can include events, e.g., telemetry data of the building subsystems 122. The graph projections can show application services as nodes and API calls between the services as edges in the graph. The graph projections can illustrate the capabilities of spaces, users, and/or devices. The graph projections can include indications of the building subsystems 122, e.g., thermostats, cameras, VAVs, etc. The graph projection database 162 can store graph projections that keep up a current state of a building.

The graph projections of the graph projection database 162 can be digital twins of a building. Digital twins can be digital replicas of physical entities that enable an in-depth analysis of data of the physical entities and provide the potential to monitor systems to mitigate risks, manage issues, and utilize simulations to test future solutions. Digital twins can play an important role in helping technicians find the root cause of issues and solve problems faster, in supporting safety and security protocols, and in supporting building managers in more efficient use of energy and other facilities resources. Digital twins can be used to enable and unify security systems, employee experience, facilities management, sustainability, etc.

In some embodiments the enrichment manager 138 can use a graph projection of the graph projection database 162 to enrich events. In some embodiments, the enrichment manager 138 can identify nodes and relationships that are associated with, and are pertinent to, the device that generated the event. For example, the enrichment manager 138 could identify a thermostat generating a temperature measurement event within the graph. The enrichment manager 138 can identify relationships between the thermostat and spaces, e.g., a zone that the thermostat is located in. The enrichment manager 138 can add an indication of the zone to the event.

Furthermore, the command processor 136 can be configured to utilize the graph projections to command the building subsystems 122. The command processor 136 can identify a policy for a commanding entity within the graph projection to determine whether the commanding entity has the ability to make the command. For example, the command processor 136, before allowing a user to make a command, determine, based on the graph projection database 162, to determine that the user has a policy to be able to make the command.

In some embodiments, the policies can be conditional based policies. For example, the building data platform 100 can apply one or more conditional rules to determine whether a particular system has the ability to perform an action. In some embodiments, the rules analyze a behavioral based biometric. For example, a behavioral based biometric can indicate normal behavior and/or normal behavior rules for a system. In some embodiments, when the building data platform 100 determines, based on the one or more conditional rules, that an action requested by a system does not match a normal behavior, the building data platform 100 can deny the system the ability to perform the action and/or request approval from a higher level system.

For example, a behavior rule could indicate that a user has access to log into a system with a particular IP address between 8 A.M. through 5 P.M. However, if the user logs in to the system at 7 P.M., the building data platform 100 may contact an administrator to determine whether to give the user permission to log in.

The change feed generator 152 can be configured to generate a feed of events that indicate changes to the digital twin, e.g., to the graph. The change feed generator 152 can track changes to the entities, relationships, and/or events of the graph. For example, the change feed generator 152 can detect an addition, deletion, and/or modification of a node or edge of the graph, e.g., changing the entities, relationships, and/or events within the database 160. In response to detecting a change to the graph, the change feed generator 152 can generate an event summarizing the change. The event can indicate what nodes and/or edges have changed and how the nodes and edges have changed. The events can be posted to a topic by the change feed generator 152.

The change feed generator 152 can implement a change feed of a knowledge graph. The building data platform 100 can implement a subscription to changes in the knowledge graph. When the change feed generator 152 posts events in the change feed, subscribing systems or applications can receive the change feed event. By generating a record of all changes that have happened, a system can stage data in different ways, and then replay the data back in whatever order the system wishes. This can include running the changes sequentially one by one and/or by jumping from one major change to the next. For example, to generate a graph at a particular time, all change feed events up to the particular time can be used to construct the graph.

The change feed can track the changes in each node in the graph and the relationships related to them, in some embodiments. If a user wants to subscribe to these changes and the user has proper access, the user can simply submit a web API call to have sequential notifications of each change that happens in the graph. A user and/or system can replay the changes one by one to reinstitute the graph at any given time slice. Even though the messages are “thin” and only include notification of change and the reference “id/seq id,” the change feed can keep a copy of every state of each node and/or relationship so that a user and/or system can retrieve those past states at any time for each node. Furthermore, a consumer of the change feed could also create dynamic “views” allowing different “snapshots” in time of what the graph looks like from a particular context. While the twin manager 108 may contain the history and the current state of the graph based upon schema evaluation, a consumer can retain a copy of that data, and thereby create dynamic views using the change feed.

In some embodiments, the schema and ontology 154 can define the message schema and graph ontology of the twin manager 108. The message schema can define what format messages received by the messaging manager 140 should have, e.g., what parameters, what formats, etc. The ontology can define graph projections, e.g., the ontology that a user wishes to view. For example, various systems, applications, and/or users can be associated with a graph ontology. Accordingly, when the graph projection manager 156 generates a graph projection for a user, system, or subscription, the graph projection manager 156 can generate a graph projection according to the ontology specific to the user. For example, the ontology can define what types of entities are related in what order in a graph, for example, for the ontology for a subscription of “Customer A,” the graph projection manager 156 can create relationships for a graph projection based on the rule:
Region [symbol] Building [symbol] Floor [symbol] Space [symbol] Asset

For the ontology of a subscription of “Customer B,” the graph projection manager 156 can create relationships based on the rule:
Building [symbol] Floor [symbol] Asset

The policy manager 158 can be configured to respond to requests from other applications and/or systems for policies. The policy manager 158 can consult a graph projection to determine what permissions different applications, users, and/or devices have. The graph projection can indicate various permissions that different types of entities have and the policy manager 158 can search the graph projection to identify the permissions of a particular entity. The policy manager 158 can facilitate fine grain access control with user permissions. The policy manager 158 can apply permissions across a graph, e.g., if “user can view all data associated with floor 1” then they see all subsystem data for that floor, e.g., surveillance cameras, HVAC devices, fire detection and response devices, etc.

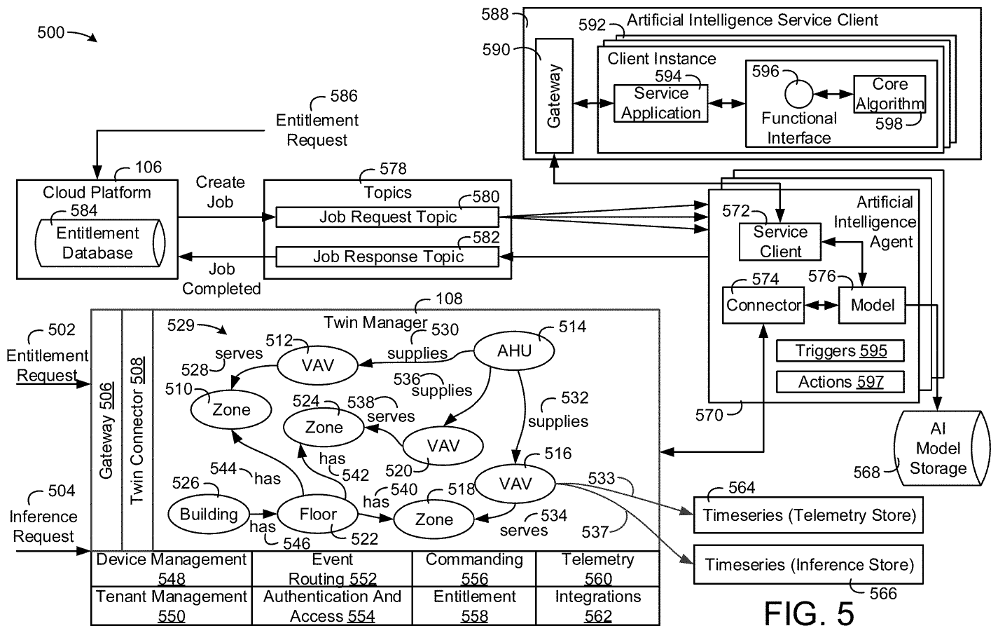

The twin manager 108 includes a query manager 165 and a twin function manager 167. The query manger 164 can be configured to handle queries received from a requesting system, e.g., the user device 176, the applications 110, and/or any other system. The query manager 165 can receive queries that include query parameters and context. The query manager 165 can query the graph projection database 162 with the query parameters to retrieve a result. The query manager 165 can then cause an event processor, e.g., a twin function, to operate based on the result and the context. In some embodiments, the query manager 165 can select the twin function based on the context and/or perform operates based on the context. In some embodiments, the query manager 165 is configured to perform the operations described with reference to FIGS. 5-10.

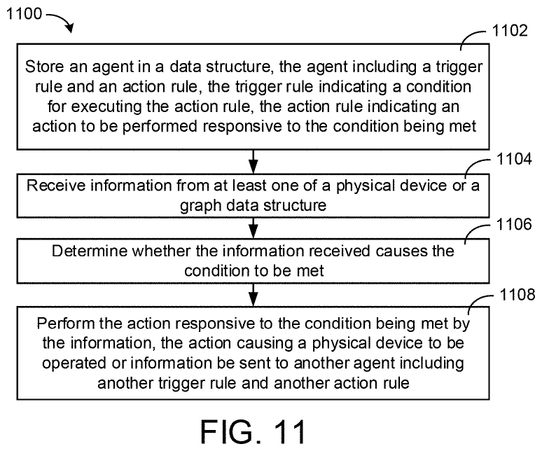

The twin function manager 167 can be configured to manage the execution of twin functions. The twin function manager 167 can receive an indication of a context query that identifies a particular data element and/or pattern in the graph projection database 162. Responsive to the particular data element and/or pattern occurring in the graph projection database 162 (e.g., based on a new data event added to the graph projection database 162 and/or change to nodes or edges of the graph projection database 162), the twin function manager 167 can cause a particular twin function to execute. The twin function can execute based on an event, context, and/or rules. The event can be data that the twin function executes against. The context can be information that provides a contextual description of the data, e.g., what device the event is associated with, what control point should be updated based on the event, etc. The twin function manager 167 can be configured to perform the operations of the FIGS. 11-15.

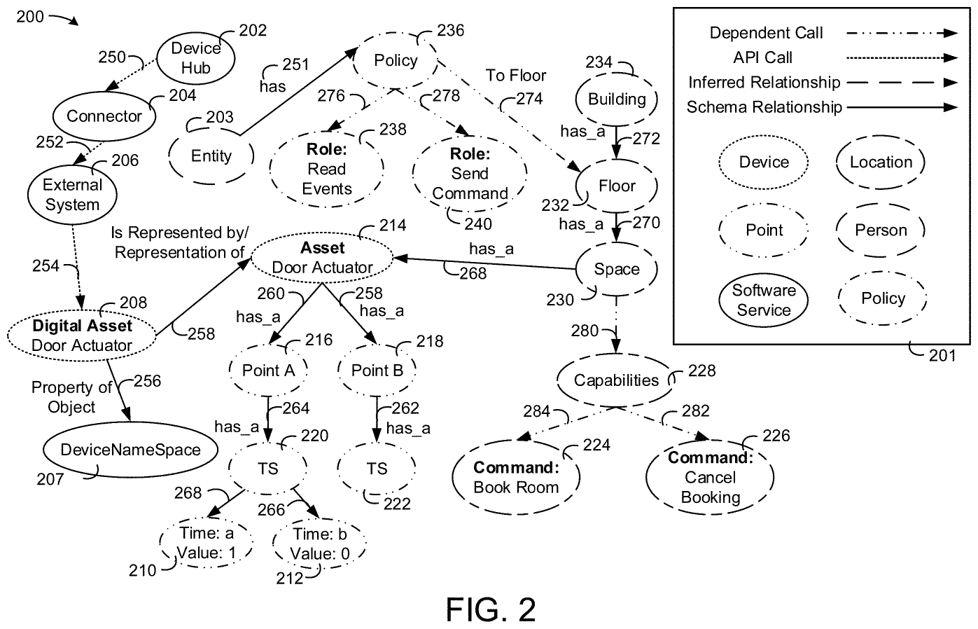

Referring now to FIG. 2, a graph projection 200 of the twin manager 108 including application programming interface (API) data, capability data, policy data, and services is shown, according to an exemplary embodiment. The graph projection 200 includes nodes 202-240 and edges 250-272. The nodes 202-240 and the edges 250-272 are defined according to the key 201. The nodes 202-240 represent different types of entities, devices, locations, points, persons, policies, and software services (e.g., API services). The edges 250-272 represent relationships between the nodes 202-240, e.g., dependent calls, API calls, inferred relationships, and schema relationships (e.g., BRICK relationships).

The graph projection 200 includes a device hub 202 which may represent a software service that facilitates the communication of data and commands between the cloud platform 106 and a device of the building subsystems 122, e.g., door actuator 214. The device hub 202 is related to a connector 204, an external system 206, and a digital asset “Door Actuator” 208 by edge 250, edge 252, and edge 254.

The cloud platform 106 can be configured to identify the device hub 202, the connector 204, the external system 206 related to the door actuator 214 by searching the graph projection 200 and identifying the edges 250-254 and edge 258. The graph projection 200 includes a digital representation of the “Door Actuator,” node 208. The digital asset “Door Actuator” 208 includes a “DeviceNameSpace” represented by node 207 and related to the digital asset “Door Actuator” 208 by the “Property of Object” edge 256.

The “Door Actuator” 214 has points and timeseries. The “Door Actuator” 214 is related to “Point A” 216 by a “has_a” edge 260. The “Door Actuator” 214 is related to “Point B” 218 by a “has_A” edge 258. Furthermore, timeseries associated with the points A and B are represented by nodes “TS” 220 and “TS” 222. The timeseries are related to the points A and B by “has_a” edge 264 and “has_a” edge 262. The timeseries “TS” 220 has particular samples, sample 210 and 212 each related to “TS” 220 with edges 268 and 266 respectively. Each sample includes a time and a value. Each sample may be an event received from the door actuator that the cloud platform 106 ingests into the entity, relationship, and event database 160, e.g., ingests into the graph projection 200.

The graph projection 200 includes a building 234 representing a physical building. The building includes a floor represented by floor 232 related to the building 234 by the “has_a” edge from the building 234 to the floor 232. The floor has a space indicated by the edge “has_a” 270 between the floor 232 and the space 230. The space has particular capabilities, e.g., is a room that can be booked for a meeting, conference, private study time, etc. Furthermore, the booking can be canceled. The capabilities for the floor 232 are represented by capabilities 228 related to space 230 by edge 280. The capabilities 228 are related to two different commands, command “book room” 224 and command “cancel booking” 226 related to capabilities 228 by edge 284 and edge 282 respectively.

If the cloud platform 106 receives a command to book the space represented by the node, space 230, the cloud platform 106 can search the graph projection 200 for the capabilities for the 228 related to the space 230 to determine whether the cloud platform 106 can book the room.

In some embodiments, the cloud platform 106 could receive a request to book a room in a particular building, e.g., the building 234. The cloud platform 106 could search the graph projection 200 to identify spaces that have the capabilities to be booked, e.g., identify the space 230 based on the capabilities 228 related to the space 230. The cloud platform 106 can reply to the request with an indication of the space and allow the requesting entity to book the space 230.

The graph projection 200 includes a policy 236 for the floor 232. The policy 236 is related set for the floor 232 based on a “To Floor” edge 274 between the policy 236 and the floor 232. The policy 236 is related to different roles for the floor 232, read events 238 via edge 276 and send command 240 via edge 278. The policy 236 is set for the entity 203 based on has edge 251 between the entity 203 and the policy 236.

The twin manager 108 can identify policies for particular entities, e.g., users, software applications, systems, devices, etc. based on the policy 236. For example, if the cloud platform 106 receives a command to book the space 230. The cloud platform 106 can communicate with the twin manager 108 to verify that the entity requesting to book the space 230 has a policy to book the space. The twin manager 108 can identify the entity requesting to book the space as the entity 203 by searching the graph projection 200. Furthermore, the twin manager 108 can further identify the edge has 251 between the entity 203 and the policy 236 and the edge 1178 between the policy 236 and the command 240.

Furthermore, the twin manager 108 can identify that the entity 203 has the ability to command the space 230 based on the edge 1174 between the policy 236 and the edge 270 between the floor 232 and the space 230. In response to identifying the entity 203 has the ability to book the space 230, the twin manager 108 can provide an indication to the cloud platform 106.

Furthermore, if the entity makes a request to read events for the space 230, e.g., the sample 210 and the sample 212, the twin manager 108 can identify the edge has 251 between the entity 203 and the policy 236, the edge 1178 between the policy 236 and the read events 238, the edge 1174 between the policy 236 and the floor 232, the “has_a” edge 270 between the floor 232 and the space 230, the edge 268 between the space 230 and the door actuator 214, the edge 260 between the door actuator 214 and the point A 216, the “has_a” edge 264 between the point A 216 and the TS 220, and the edges 268 and 266 between the TS 220 and the samples 210 and 212 respectively.

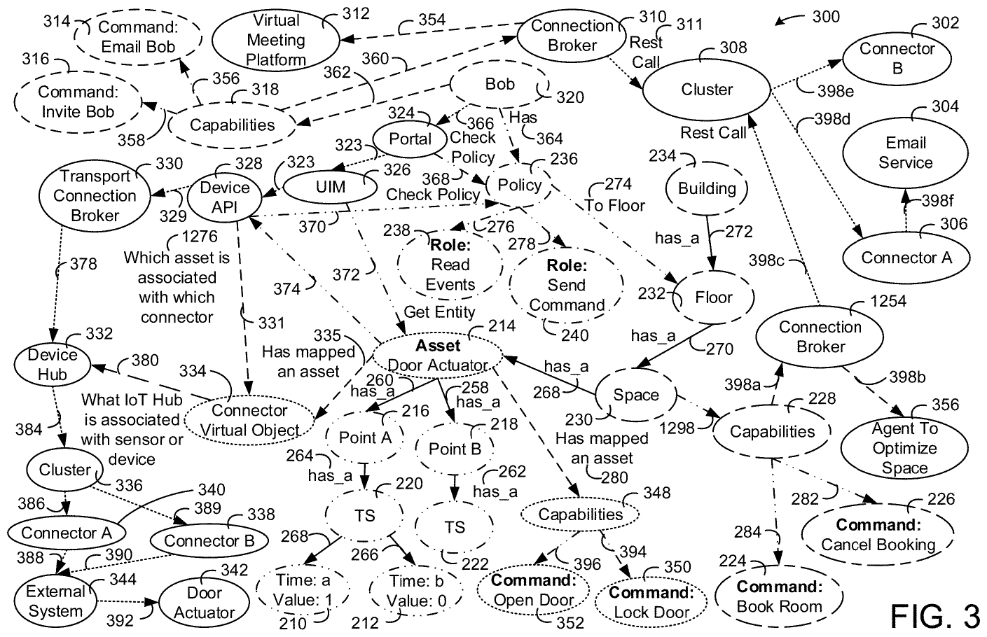

Referring now to FIG. 3, a graph projection 300 of the twin manager 108 including application programming interface (API) data, capability data, policy data, and services is shown, according to an exemplary embodiment. The graph projection 300 includes the nodes and edges described in the graph projection 200 of FIG. 2. The graph projection 300 includes a connection broker 354 related to capabilities 228 by edge 398a. The connection broker 354 can be a node representing a software application configured to facilitate a connection with another software application. In some embodiments, the cloud platform 106 can identify the system that implements the capabilities 228 by identifying the edge 398a between the capabilities 228 and the connection broker 354.

The connection broker 354 is related to an agent that optimizes a space 356 via edge 398b. The agent represented by the node 356 can book and cancel bookings for the space represented by the node 230 based on the edge 398b between the connection broker 354 and the node 356 and the edge 398a between the capabilities 228 and the connection broker 354.

The connection broker 354 is related to a cluster 308 by edge 398c. Cluster 308 is related to connector B 302 via edge 398e and connector A 306 via edge 398d. The connector A 306 is related to an external subscription service 304. A connection broker 310 is related to cluster 308 via an edge 311 representing a rest call that the connection broker represented by node 310 can make to the cluster represented by cluster 308.

The connection broker 310 is related to a virtual meeting platform 312 by an edge 354. The node 312 represents an external system that represents a virtual meeting platform. The connection broker represented by node 310 can represent a software component that facilitates a connection between the cloud platform 106 and the virtual meeting platform represented by node 312. When the cloud platform 106 needs to communicate with the virtual meeting platform represented by the node 312, the cloud platform 106 can identify the edge 354 between the connection broker 310 and the virtual meeting platform 312 and select the connection broker represented by the node 310 to facilitate communication with the virtual meeting platform represented by the node 312.

A capabilities node 318 can be connected to the connection broker 310 via edge 360. The capabilities 318 can be capabilities of the virtual meeting platform represented by the node 312 and can be related to the node 312 through the edge 360 to the connection broker 310 and the edge 354 between the connection broker 310 and the node 312. The capabilities 318 can define capabilities of the virtual meeting platform represented by the node 312. The node 320 is related to capabilities 318 via edge 362. The capabilities may be an invite bob command represented by node 316 and an email bob command represented by node 314. The capabilities 318 can be linked to a node 320 representing a user, Bob. The cloud platform 106 can facilitate email commands to send emails to the user Bob via the email service represented by the node 304. The node 304 is related to connect a node 306 via edge 398f. Furthermore, the cloud platform 106 can facilitate sending an invite for a virtual meeting via the virtual meeting platform represented by the node 312 linked to the node 318 via the edge 358.

The node 320 for the user Bob can be associated with the policy 236 via the “has” edge 364. Furthermore, the node 320 can have a “check policy” edge 366 with a portal node 324. The device API node 328 has a check policy edge 370 to the policy node 236. The portal node 324 has an edge 368 to the policy node 236. The portal node 324 has an edge 323 to a node 326 representing a user input manager (UIM). The portal node 324 is related to the UIM node 326 via an edge 323. The UIM node 326 has an edge 323 to a device API node 328. The UIM node 326 is related to the door actuator node 214 via edge 372. The door actuator node 214 has an edge 374 to the device API node 328. The door actuator 214 has an edge 335 to the connector virtual object 334. The device hub 332 is related to the connector virtual object via edge 380. The device API node 328 can be an API for the door actuator 214. The connector virtual object 334 is related to the device API node 328 via the edge 331.

The device API node 328 is related to a transport connection broker 330 via an edge 329. The transport connection broker 330 is related to a device hub 332 via an edge 378. The device hub represented by node 332 can be a software component that hands the communication of data and commands for the door actuator 214. The cloud platform 106 can identify where to store data within the graph projection 300 received from the door actuator by identifying the nodes and edges between the points 216 and 218 and the device hub node 332. Similarly, the cloud platform 308 can identify commands for the door actuator that can be facilitated by the device hub represented by the node 332, e.g., by identifying edges between the device hub node 332 and an open door node 352 and a lock door node 350. The door actuator 114 has an edge “has mapped an asset” 280 between the node 214 and a capabilities node 348. The capabilities node 348 and the nodes 352 and 350 are linked by edges 396 and 394.

The device hub 332 is linked to a cluster 336 via an edge 384. The cluster 336 is linked to connector A 340 and connector B 338 by edges 386 and the edge 389. The connector A 340 and the connector B 338 is linked to an external system 344 via edges 388 and 390. The external system 344 is linked to a door actuator 342 via an edge 392.

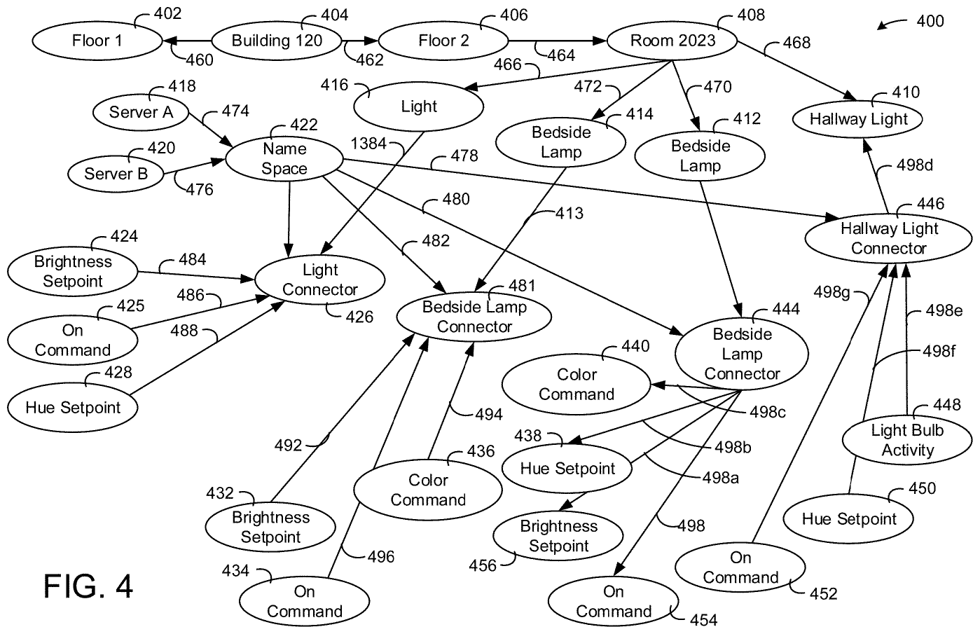

Referring now to FIG. 4, a graph projection 400 of the twin manager 108 including equipment and capability data for the equipment is shown, according to an exemplary embodiment. The graph projection 400 includes nodes 402-456 and edges 360-498f. The cloud platform 106 can search the graph projection 400 to identify capabilities of different pieces of equipment.

A building node 404 represents a particular building that includes two floors. A floor 1 node 402 is linked to the building node 404 via edge 460 while a floor 2 node 406 is linked to the building node 404 via edge 462. The floor 2 includes a particular room 2023 represented by edge 464 between floor 2 node 406 and room 2023 node 408. Various pieces of equipment are included within the room 2023. A light represented by light node 416, a bedside lamp node 414, a bedside lamp node 412, and a hallway light node 410 are related to room 2023 node 408 via edge 466, edge 472, edge 470, and edge 468.

The light represented by light node 416 is related to a light connector 426 via edge 484. The light connector 426 is related to multiple commands for the light represented by the light node 416 via edges 484, 486, and 488. The commands may be a brightness setpoint 424, an on command 425, and a hue setpoint 428. The cloud platform 106 can receive a request to identify commands for the light represented by the light 416 and can identify the nodes 424-428 and provide an indication of the commands represented by the node 424-428 to the requesting entity. The requesting entity can then send commands for the commands represented by the nodes 424-428.

The bedside lamp node 414 is linked to a bedside lamp connector 481 via an edge 413. The connector 481 is related to commands for the bedside lamp represented by the bedside lamp node 414 via edges 492, 496, and 494. The command nodes are a brightness setpoint node 432, an on command node 434, and a color command 436. The hallway light 410 is related to a hallway light connector 446 via an edge 498d. The hallway light connector 446 is linked to multiple commands for the hallway light node 410 via edges 498g, 498f, and 498e. The commands are represented by an on command node 452, a hue setpoint node 450, and a light bulb activity node 448.

The graph projection 400 includes a name space node 422 related to a server A node 418 and a server B node 420 via edges 474 and 476. The name space node 422 is related to the bedside lamp connector 481, the bedside lamp connector 444, and the hallway light connector 446 via edges 482, 480, and 478. The bedside lamp connector 444 is related to commands, e.g., the color command node 440, the hue setpoint command 438, a brightness setpoint command 456, and an on command 454 via edges 498c, 498b, 498a, and 498.

Referring now to FIG. 5, a system 500 for managing a digital twin where an artificial intelligence agent can be executed to infer and/or predict information for an entity of a graph is shown, according to an exemplary embodiment. The system 500 can be components of the building data platform 100, e.g., components run on the processors and memories of the edge platform 102, the cloud platform 106, the twin manager 108, and/or the applications 110. The system 500 can, in some implementations, implement a digital twin with artificial intelligence.

A digital twin (or a shadow) may be a computing entity that describes a physical thing (e.g., a building, spaces of a building, devices of a building, people of the building, equipment of the building, etc.) through modeling the physical thing through a set of attributes that define the physical thing. A digital twin can refer to a digital replica of physical assets (a physical device twin) and can be extended to store processes, people, places, systems that can be used for various purposes. The digital twin can include both the ingestion of information and actions learned and executed through artificial intelligence agents.

In FIG. 5, the digital twin can be a graph 529 managed by the twin manager 108 and/or artificial intelligence agents 570. In some embodiments, the digital twin is the combination of the graph 529 with the artificial intelligence agents 570. In some embodiments, the digital twin enables the creation of a chronological time-series database of telemetry events for analytical purposes. In some embodiments, the graph 529 uses the BRICK schema.

The twin manager 108 stores the graph 529 which may be a graph data structure including various nodes and edges interrelating the nodes. The graph 529 may be the same as, or similar to, the graph projections described herein with reference to FIGS. 1-4. The graph 529 includes nodes 510-526 and edges 528-546. The graph 529 includes a building node 526 representing a building that has a floor indicated by the “has” edge 546 to the floor node 522. The floor node 522 is relate to a zone node 510 via a “has” edge 544 indicating that the floor represented by the node 522 has a zone represented by the zone 510.

The floor node 522 is related to the zone node 518 by the “has” edge 540 indicating that the floor represented by the floor node 522 has another zone represented by the zone node 518. The floor node 522 is related to another zone node 524 via a “has” edge 542 representing that the floor represented by the floor node 522 has a third zone represented by the zone node 524.

The graph 529 includes an AHU node 514 representing an AHU of the building represented by the building node 526. The AHU node 514 is related by a “supplies” edge 530 to the VAV node 512 to represent that the AHU represented by the AHU node 514 supplies air to the VAV represented by the VAV node 512. The AHU node 514 is related by a “supplies” edge 536 to the VAV node 520 to represent that the AHU represented by the AHU node 514 supplies air to the VAV represented by the VAV node 520. The AHU node 514 is related by a “supplies” edge 532 to the VAV node 516 to represent that the AHU represented by the AHU node 514 supplies air to the VAV represented by the VAV node 516.

The VAV node 516 is related to the zone node 518 via the “serves” edge 534 to represent that the VAV represented by the VAV node 516 serves (e.g., heats or cools) the zone represented by the zone node 518. The VAV node 520 is related to the zone node 524 via the “serves” edge 538 to represent that the VAV represented by the VAV node 520 serves (e.g., heats or cools) the zone represented by the zone node 524. The VAV node 512 is related to the zone node 510 via the “serves” edge 528 to represent that the VAV represented by the VAV node 512 serves (e.g., heats or cools) the zone represented by the zone node 510.

Furthermore, the graph 529 includes an edge 533 related to a timeseries node 564. The timeseries node 564 can be information stored within the graph 529 and/or can be information stored outside the graph 529 in a different database (e.g., a timeseries database). In some embodiments, the timeseries node 564 stores timeseries data (or any other type of data) for a data point of the VAV represented by the VAV node 516. The data of the timeseries node 564 can be aggregated and/or collected telemetry data of the timeseries node 564.

Furthermore, the graph 529 includes an edge 537 related to a timeseries node 566. The timeseries node 566 can be information stored within the graph 529 and/or can be information stored outside the graph 529 in a different database (e.g., a timeseries database). In some embodiments, the timeseries node 566 stores timeseries data (or any other type of data) for a data point of the VAV represented by the VAV node 516. The data of the timeseries node 564 can be inferred information, e.g., data inferred by one of the artificial intelligence agents 570 and written into the timeseries node 564 by the artificial intelligence agent 570. In some embodiments, the timeseries 546 and/or 566 are stored in the graph 529 but are stored as references to timeseries data stored in a timeseries database.

The twin manager 108 includes various software components. For example, the twin manager 108 includes a device management component 548 for managing devices of a building. The twin manager 108 includes a tenant management component 550 for managing various tenant subscriptions. The twin manager 108 includes an event routing component 552 for routing various events. The twin manager 108 includes an authentication and access component 554 for performing user and/or system authentication and grating the user and/or system access to various spaces, pieces of software, devices, etc. The twin manager 108 includes a commanding component 556 allowing a software application and/or user to send commands to physical devices. The twin manager 108 includes an entitlement component 558 that analyzes the entitlements of a user and/or system and grants the user and/or system abilities based on the entitlements. The twin manager 108 includes a telemetry component 560 that can receive telemetry data from physical systems and/or devices and ingest the telemetry data into the graph 529. Furthermore, the twin manager 108 includes an integrations component 562 allowing the twin manager 108 to integrate with other applications.

The twin manager 108 includes a gateway 506 and a twin connector 508. The gateway 506 can be configured to integrate with other systems and the twin connector 508 can be configured to allow the gateway 506 to integrate with the twin manager 108. The gateway 506 and/or the twin connector 508 can receive an entitlement request 502 and/or an inference request 504. The entitlement request 502 can be a request received from a system and/or a user requesting that an AI agent action be taken by the AI agent 570. The entitlement request 502 can be checked against entitlements for the system and/or user to verify that the action requested by the system and/or user is allowed for the user and/or system. The inference request 504 can be a request that the AI agent 570 generates an inference, e.g., a projection of information, a prediction of a future data measurement, an extrapolated data value, etc.

The cloud platform 106 is shown to receive an entitlement request 586. The request 586 can be received from a system, application, and/or user device (e.g., from the applications 110, the building subsystems 122, and/or the user device 176). The entitlement request 586 may be a manual or automated request. In some embodiments, the request 586 can be automated via an API request, e.g., when such an entitlement to an AI model is enabled for a particular tenant/end-customer of the data platform 100. In some embodiments, the request 586 may be a manual request by a person asking for an inference/future state of the building. The request 586 could be automatically made to keep the state updated on a particular cadence. In some embodiments, a request for a future state of one digital twin can cause a re-calculation of the future states of related digital twins automatically. For example, based on a request asking for the future occupancy of a room in a building in the coming week, a re-calculation of the future AHU operating value recommendations to reduce the spread of infectious diseases may be triggered. The results of these automatic triggers determining future states not directly requested by the request 586 can be collected and presented to the caller of the request 586 as causal future states.

The entitlement request 586 may be a request for the AI agent 570 to perform an action, e.g., an action that the requesting system and/or user has an entitlement for. The cloud platform 106 can receive the entitlement request 586 and check the entitlement request 586 against an entitlement database 584 storing a set of entitlements to verify that the requesting system has access to the user and/or system. The cloud platform 106, responsive to the entitlement request 586 being approved, can create a job for the AI agent 570 to perform. The created job can be added to a job request topic 580 of a set of topics 578.

The job request topic 580 can be fed to AI agents 570. For example, the topics 580 can be fanned out to various AI agents 570 based on the AI agent that each of the topics 580 pertains to (e.g., based on an identifier that identifies an agent and is included in each job of the topic 580). The AI agents 570 include a service client 572, a connector 574, and a model 576. The model 576 can be loaded into the AI agent 570 from a set of AI models stored in the AI model storage 568. The AI model storage 568 can store models for making energy load predictions for a building, weather forecasting models for predicting a weather forecast, action/decision models to take certain actions responsive to certain conditions being met, an occupancy model for predicting occupancy of a space and/or a building, for tuning thresholds for rules, etc. The models of the AI model storage 568 can be neural networks (e.g., convolutional neural networks, recurrent neural networks, deep learning networks, etc.), decision trees, support vector machines, and/or any other type of artificial intelligence, machine learning, and/or deep learning category. In some embodiments, the models are rule based triggers and actions that include various parameters for setting a condition and defining an action.

The AI agent 570 can include triggers 595 and actions 597. The triggers 595 can be conditional rules that, when met, cause one or more of the actions 597. The triggers 595 can be executed based on information stored in the graph 529 and/or data received from the building subsystems 122. The actions 597 can be executed to determine commands, actions, and/or outputs. The output of the actions 597 can be stored in the graph 529 and/or communicated to the building subsystems 122.

In some embodiments, the triggers 595 and/or the actions 597 are stored as nodes in the graph 529. The nodes for the triggers 595 and/or the actions 597 can be stored as capability nodes. Capability nodes may be nodes that describe operations that a digital twin can perform (e.g., is configured and/or capable of performing). Capabilities are described with reference to FIGS. 1-4. In some embodiments, the graph 529 stores a first node representing a particular digital twin, agent, artificial intelligence, machine learning entity, etc. The graph 529 can further store one or more second nodes related to the first node via one or more edges (or one or more nodes). The one or more second nodes may describe capabilities of the digital twin, agent, artificial intelligence, machine learning entity, etc. The capabilities may be triggers and/or actions (e.g., the triggers 595 and/or actions 597). The first node may be related to a particular component node (e.g., the VAV node 516) via another edge to represent that the digital twin, agent, artificial intelligence, machine learning entity, etc. makes inferences or other data determinations for the component (e.g., a VAV) represented by the particular component node (e.g., the VAV node 516).

The AI agent 570 can include a service client 572 that causes an instance of an AI agent to run. The instance can be hosted by the artificial intelligence service client 588. The client 588 can cause a client instance 592 to run and communicate with the AI agent 570 via a gateway 590. The client instance 592 can include a service application 594 that interfaces with a core algorithm 598 via a functional interface 596. The core algorithm 598 can run the model 576, e.g., train the model 576 and/or use the model 576 to make inferences and/or predictions.

In some embodiments, the core algorithm 598 can be configured to perform learning based on the graph 529. In some embodiments, the core algorithm 598 can read and/or analyze the nodes and relationships of the graph 529 to make decisions. In some embodiments, the core algorithm 598 can be configured to use telemetry data (e.g., the timeseries data 564) from the graph 529 to make inferences on and/or perform model learning. In some embodiments, the result of the inferences can be the timeseries 566. In some embodiments, the timeseries 564 is an input into the model 576 that predicts the timeseries 566.

In some embodiments, the core algorithm 598 can generate the timeseries 566 as an inference for a data point, e.g., a prediction of values for the data point at future times. The timeseries 564 may be actual data for the data point. In some embodiments, the core algorithm 598 can learn and train by comparing the inferred data values against the true data values. In some embodiments, the model 576 can be trained by the core algorithm 598 to improve the inferences made by the model 576.

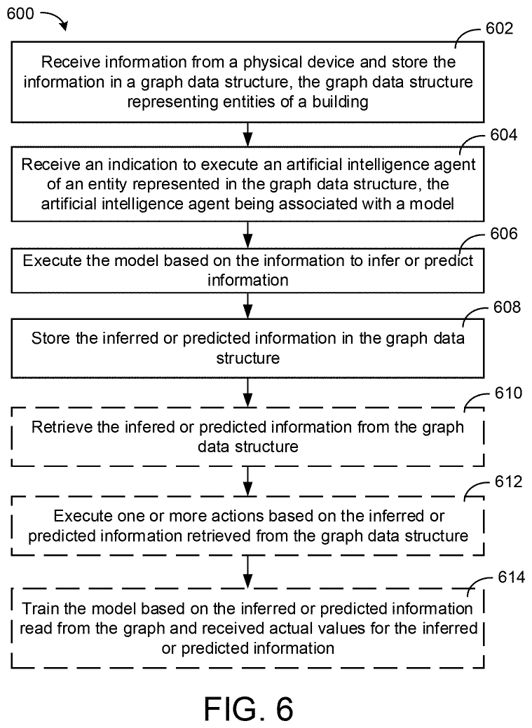

Referring now to FIG. 6, a process 600 for executing an artificial intelligence agent to infer and/or predict information is shown, according to an exemplary embodiment. The process 600 can be performed by the system 500 and/or components of the system 500. The process 600 can be performed by the building data platform 100. Furthermore, the process 600 can be performed by any computing device described herein.

In step 602, the twin manager 108 receives information from a physical device and stores the information, or a link to the information, in the graph 529. For example, the telemetry component 560 can receive telemetry data from physical devices, e.g., the building subsystems 122. The telemetry can be measured data values, a log of historical equipment commands, etc. The telemetry component 560 can store the received information in the graph 529 by relating a node storing the information to a node representing the physical device. For example, the telemetry component 560 can store timeseries data as the timeseries 566 along by identifying that the physical device is a VAV represented by the VAV node 516 and that an edge 537 relates the VAV node 516 to the timeseries node 566.

In step 604, the twin manager 108 and/or the cloud platform 106 receives an indication to execute an artificial intelligence agent of an entity represented in the graph 529, the AI agent being associated with a model. In some embodiments, the indication is created by a user and provided via the user device 176. In some embodiments, the indication is created by an application, e.g., one of the applications 110. In some embodiments, the indication is a triggering event that triggers the agent and is received from the building subsystems 122 and/or another agent (e.g., an output of one agent fed into another agent).

In some embodiments, the AI agent is an agent for a specific entity represented in the graph 529. For example, the agent could be a VAV maintenance agent configured to identify whether a VAV (e.g., a VAV represented by the nodes 512, 530, and/or 516) should have maintenance performed at a specific time. Another agent could be a floor occupant prediction agent that is configure to predict the occupancy of a particular floor of a building, e.g., the floor represented by the floor node 522.

Responsive to receiving the indication, in step 606, the AI agent 570 causes a client instance 592 to run the model 576 based on the information received in step 602. In some embodiments, the information received in step 602 is provided directly to the AI agent 570. In some embodiments, the information is read from the graph 529 by the AI agent 570.

In step 608, the AI agent 570 stores the inferred and/or predicted information in the graph 529 (or stores the inferred and/or predicted information in a separate data structure with a link to the graph 529). In some embodiments, the AI agent 570 identifies that the node that represents the physical entity that the AI agent 570 inferred and/or predicted information for, e.g., the VAV represented by the VAV 516. The AI agent 570 can identify that the timeseries node 566 stores the inferred and/or predicted information by identifying the edge 537 between the VAV node 516 and the timeseries node 566.

In step 610, the AI agent 570 can retrieve the inferred or predicted information from the graph 529 responsive to receiving an indication to execute the model of the AI agent 570 of the inferred or predicted information, e.g., similar to the step 604. In step 612, the AI agent 570 can execute one or more actions based on the inferred and/or predicted information of the step 610 based the inferred and/or predicted information retrieved from the graph 529. In some embodiments, the AI agent 570 executes the model 576 based on the inferred and/or predicted information.

In step 614, the AI agent 570 can train the model 576 based on the inferred or predicted information read from the graph 529 and received actual values for the inferred or predicted information. In some embodiments, the AI agent 570 can train and update parameters of the model 576. For example, the timeseries 564 may represent actual values for a data point of the VAV represented by the VAV node 516. The timeseries 566 can be the inferred and/or predicted information. The AI agent 570 can compare the timeseries 564 and the timeseries 566 to determine an error in the inferences and/or predictions of the model 576. The error can be used by the model 576 to update and train the model 576.

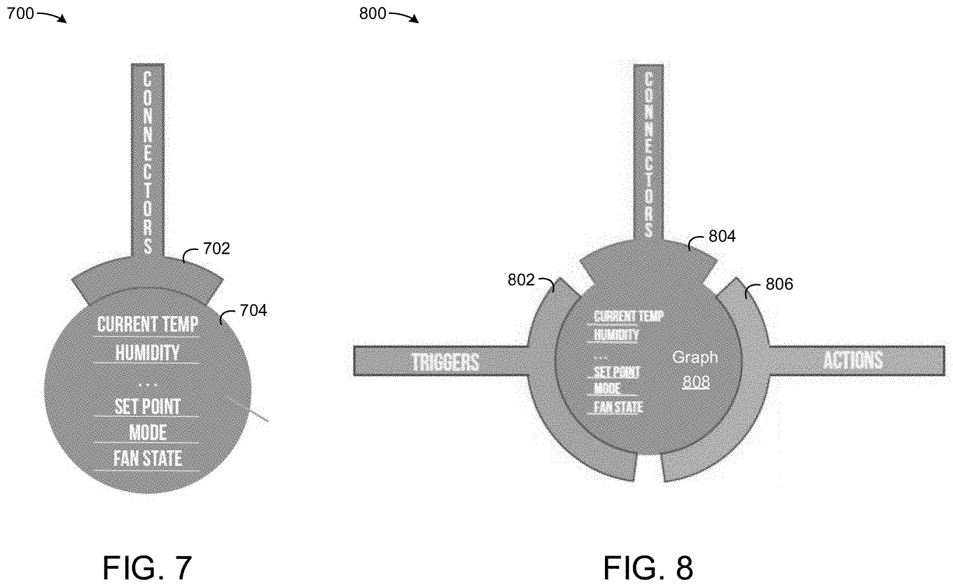

Referring now to FIG. 7, a digital twin 700 including a connector and a database is shown, according to an exemplary embodiment. The digital twin 700 can be a software component stored and/or managed by the building data platform 100. The building data platform 100 includes connectors 702 and a database 704. The database 704 can store data attributes for a physical entity, e.g., a building, a VAV, etc. that describe the current state and/or operation of the physical entity. The connector 702 can be a software component that receives data from the physical device represented by the digital twin 700 and updates the attributes of the database 704. For example, the connector 702 can ingest device telemetry data into the database 704 to update the attributes of the digital twin 700.

Referring now to FIG. 8, a digital twin 800 including triggers 802, connectors 804, actions 806, and a graph 808 is shown, according to an exemplary embodiment. The digital twin 800 can be a digital replica of physical assets (e.g., a physical device twin, sensor twin, actuator twin, building device twin, etc.) and can be used to store processes, people, places, systems that can be used for various purposes. The digital twins can be created, managed, stored, and/or operated on by the building data platform 100.

In some cases, the devices can also be actuated on (told to perform an action). For example, a thermostat has sensors to measure temperature and humidity. A thermostat can also be asked to perform an action of setting the setpoint for a HVAC system. In some embodiments, the digital twin 800 can be configured so that information that the digital twin 800 can be made aware of can be stored by the digital twin 800 and there are also actions that the digital twin 800 can take.

The digital twin 800 can include a connector 804 that ingests device telemetry into the graph 808 and/or update the digital twin attributes stored in the graph 808. In some embodiments, the connectors 804 can ingest external data received from external data sources into the graph 808. The external data could be weather data, calendar data, etc. In some embodiments, the connectors 804 can send commands back to the devices, e.g., the actions determined by the actions 806.

The digital twin 800 includes triggers 802 which can set conditional logic for triggering the actions 806. The digital twin 800 can apply the attributes stored in the graph 808 against a rule of the triggers 802. When a particular condition of the rule of the triggers 802 involving that attribute is met, the actions 806 can execute. One example of a trigger could be a conditional question, “when the temperature of the zone managed by the thermostat reaches x degrees Fahrenheit.” When the question is met by the attributes stored in the graph 808, a rule of the actions 806 can execute.

The digital twin 800 can, when executing the actions 806, update an attribute of the graph 808, e.g., a setpoint, an operating setting, etc. These attributes can be translated into commands that the building data platform 100 can send to physical devices that operate based on the setpoint, the operating setting, etc. An example of an action rule for the actions 806 could be the statement, “update the setpoint of the HVAC system for a zone to x Degrees Fahrenheit.”

In some embodiments, the triggers 802 and/or the actions 806 are predefined and/or manually defined through user input of the user device 176. In some cases, it may be difficult for a user to determine what the parameter values of the trigger rule should be (e.g., what values maximize a particular reward or minimize a particular penalty). Similarly, it may be difficult for a user to determine what the parameter values of the action rule should be (e.g., what values maximize the particular reward or minimize the particular penalty). Furthermore, even if the user is able to identify the ideal parameter values for the triggers 802 and the actions 806, the ideal values for the parameters may not be constant and may instead change over time. Therefore, it would be desirable if the values of the attributes for the triggers 802 and the actions 806 are tuned optimally and automatically by the building data platform 100 by observing the responses from other related digital twins.

Causal patterns between one or more digital twins having their triggering conditions satisfied and one or more digital twins (including the triggering digital twin) actuating by sending specific commands to their physical counterparts could be learned and defined by the building data platform 100. Automated learning can be used by the building data platform 100 during real operations, by running simulations using digital twins, or using predicted inference within the digital twin. There may not even be the need for all standard operating procedures in building systems to be defined upfront by a user since patterns of interaction between digital twins can be learned by the building data platform 100 to define and recommend those to building and facility owners.

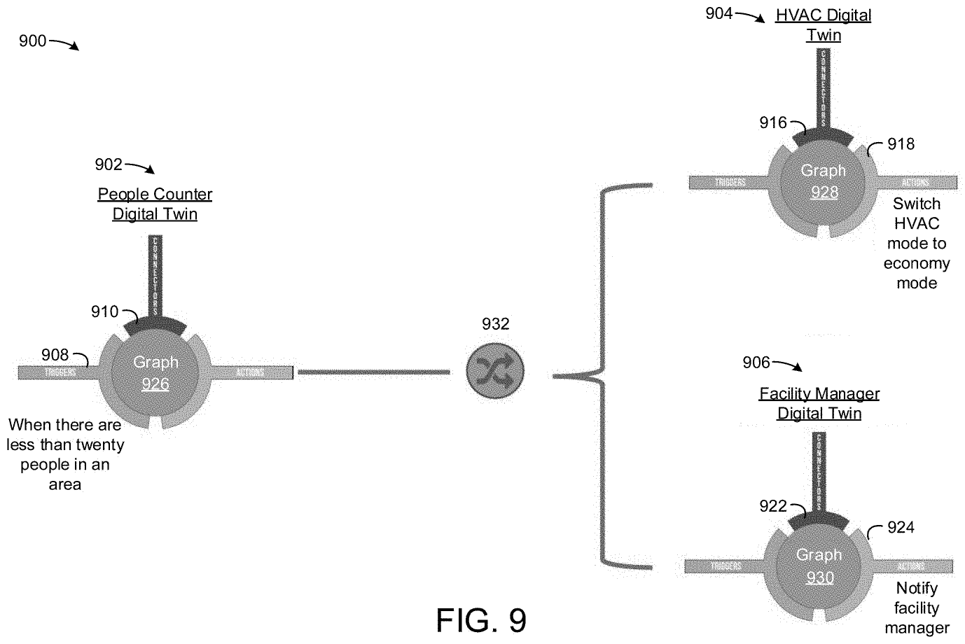

Referring now to FIG. 9, a system 900 of digital twins including a people counter digital twin 902, an HVAC digital twin 904, and a facility manager digital twin 906 that are interconnected is shown, according to an exemplary embodiment. In FIG. 9, the people counter digital twin 902 includes triggers 908, connectors 910, actions, and/or the graph 926. The system 900 further includes an HVAC digital twin 904 that includes triggers, connectors 916, actions 918, and/or the graph 928. The system 900 further includes the facility manager digital twin 906 that includes triggers, connectors 922, actions 924, and/or the graph 930. In some embodiments, the graph 926, the graph 928, and the graph 930 are the same graph or different graphs. In some embodiments, the graphs 926-930 are the graph 529.

In some embodiments, the people counter digital twin 902 can output a “low occupancy” attribute which can be stored in the graph 926 and/or provided to the HVAC digital twin 904 and/or the facility manager digital twin 906. In some embodiments, if all of the digital twins use and/or have access to the same graph, and if the people counter digital twin 902 stores the low occupancy indicator in the graph, the HVAC digital twin 904 and the facility manager digital twin 906 can read the attribute from the graph. In some embodiments, a rules engine 932 can store rules that link the twins 902, 904, and 906 together. The rules engine 932 can be included in the twin manager 108, and the rules of the rules engine 932 can be stored in the entity, relationship, and event database 160 or other database. The rules engine 932 can determine whether the triggers of the various digital twins are triggered, e.g., the trigger 908. Furthermore, the rules engine 932 can determine (based on one or more rules stored by the rules engine 932) that if the trigger 908 of the people counter digital twin 902 is triggered, the actions 918 of the HVAC digital twin 904 and the actions 924 of the facility manager digital twin 906 should be executed.

In some embodiments, the trigger 908 is the logical condition, “when there are less than twenty people in a particular area.” Responsive to an occupancy count of the particular area is less than twenty, which the people counter digital twin 902 can determine from models and/or information of the graph 926, a low occupancy indication can be generated.

Responsive to the trigger 908 being triggered, the rules engine 932 can cause the actions 918 to execute to switch an HVAC mode to an economy mode. The economy mode status for an HVAC system can be stored in the graph 928 and/or communicated to an HVAC controller to execute on. Responsive to the trigger 908 being triggered, the rules engine 932 can cause the actions 924 to execute to notify a facility manager of the low occupancy status, e.g., send a notification to a user device of the facility manager.

In some embodiments, the digital twins of the system 900 can be solution digital twins, e.g., the people counter twin 902, the HVAC digital twin 904, the facility manager twin 906, etc. The digital twin can be a solution digital twin because it represents particular software solutions for the building. For example, in some embodiments, an occupancy sensor digital twin of a zone could be triggered with under-utilized criteria (e.g., the triggering of the people counter digital twin 902 shown in FIG. 9). The people counter digital twin 902 could be configured to identify what AHU is serving the zone that it has made an occupancy detection for based on the nodes and/or edges of the graph 926 relating a zone node for the zone and an AHU node for the AHU. In some embodiments, the AHU digital twin can evaluate the desired setting for the zone through running a simulation with one or more models. In some embodiments, an FM digital twin can evaluate space arrangement and/or purposing.

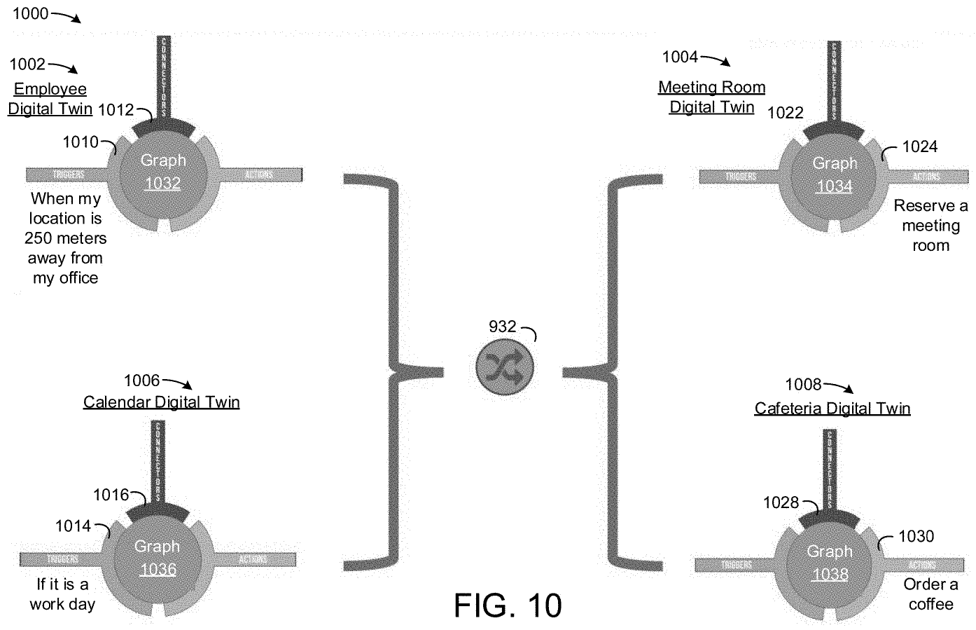

Referring now to FIG. 10, a system 1000 including an employee digital twin 1002, a calendar digital twin 1006, a meeting room digital twin 1004, and a cafeteria digital twin 1008 that are interconnected is shown, according to an exemplary embodiment. The system 1000 includes a solution digital twin for an employee, a meeting room, a cafeteria, and a calendar. In the system 1000, the employee digital twin 1002 and the calendar digital twin 1006 trigger and/or cause one or more associated digital twins, e.g., the meeting room digital twin 1004 and the cafeteria digital twin 1008, to execute responsive to the triggers. The calendar digital twin 1006 can include a connector 1016, the meeting room digital twin 1004 can include a connector 1022, and the cafeteria digital twin 1008 can include a connector 1028 for ingesting information into the graphs 1034-1038. In some embodiments, the rules engine 932 can store rules that link the twins 1002, 1006, 1004, and/or 1008 together. The rules engine 932 can determine whether the triggers of the various digital twins are triggered, e.g., the triggers 1010 and/or 1014. Furthermore, the rules engine 932 can determine (based on one or more rules stored by the rules engine 932) that if the triggers 1010 and 1014 are triggered, the actions 1024 and 1030 should be executed.

In FIG. 10, the employee digital twin 1002 includes a graph 1032, the calendar digital twin 1006 includes a graph 1036, the meeting room digital twin 1004 includes a graph 1034, and the cafeteria digital twin 1008 includes a graph 1038. The graphs 1032-1038 can be the same graphs and/or different graphs and can be the same as, or similar to, the graph 529.

The employee digital twin 1002 can generate an indication of whether a particular occupant is near a particular office via an action responsive to the trigger 1010 triggering when a particular occupant is a particular instance (e.g., 250 meters) from their office. The digital twin 1002 can identify the occupant, the occupant's office, and the location of the office through analyzing the nodes and/or edge of the graph 1032. The calendar digital twin 1006 determines, based on calendar data (e.g., calendar data stored in the graph 1036), whether it is a work day via the trigger 1014 (e.g., is a day Monday through Friday). Responsive to determining that it is a work day, the calendar digital twin 1006 generates an indication that it is a work day via actions of the calendar digital twin 1006.

The meeting room digital twin 1004 can receive the work day indication from the calendar digital twin 1006 and can receive the occupant near office indication from the employee digital twin 1002. The rules engine 932 can cause the meeting room digital twin 1004 to take actions to reserve a meeting room via the actions 1024 responsive to the triggers 1010 and 1014 being triggered. The rules engine 932 can cause the cafeteria digital twin 1008 to trigger the ordering of a coffee for the occupant via the action 1030 responsive to the triggers 1010 and 1014 being triggered.

Referring now to FIG. 11, a process 1100 of an agent executing a trigger rule and an action rule is shown, according to an exemplary embodiment. The process 1100 can be performed by the system 500 and/or components of the system 500. In some embodiments, the building data platform 100 can perform the process 1100. Furthermore, the process 1100 can be performed by any computing device described herein.

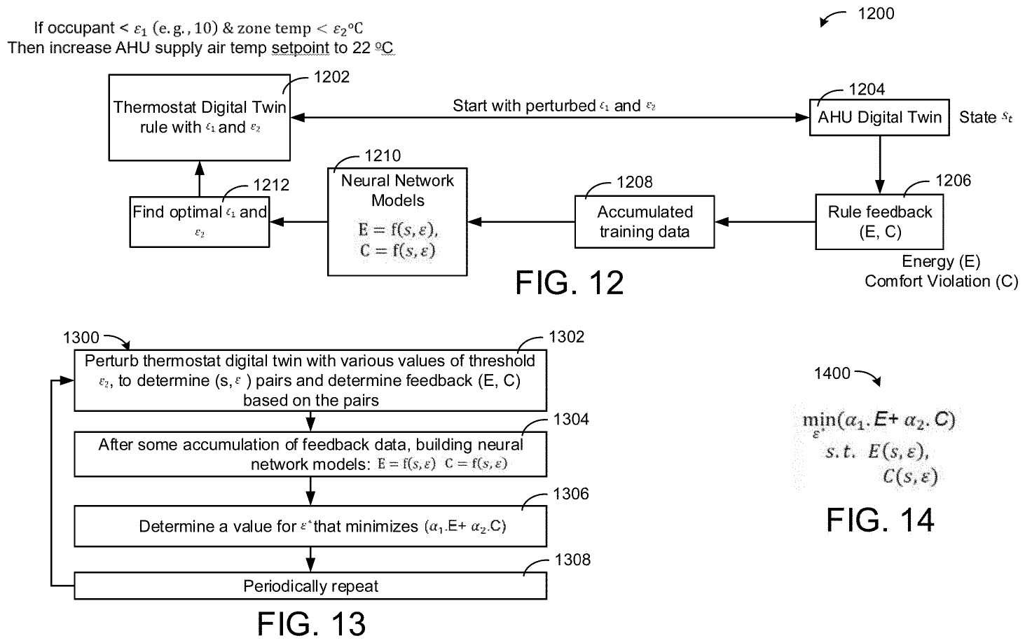

In step 1102, the building data platform can store an agent (e.g., agent 570) in a data structure. The agent can include a trigger rule indicating a condition for executing an action rule and an action rule indicating an action to be performed responsive to the condition being met. In some embodiments, the model 576 includes, or can be replaced with, the trigger rule and the action rule. The trigger rule and the action rule can be logical statements and/or conditions that include parameter values and/or create an output action. In some embodiments, the parameter values can be identified through a learning process, e.g., as described through FIGS. 12-22.

In step 1104, the agent can receive information from at least one of a physical device and/or from a graph (e.g., graph 529). The information can be generated by a physical device, e.g., the building subsystems 122. In some embodiments, the building data platform can receive the information from the physical device, ingest the information into the graph, and the agent can read the information from the graph. In some embodiments, the agent can check the information of the graph against a trigger rule at a set period.

In step 1106, the agent determines whether the information received in the step 1104 causes the condition to be met. The agent can apply the information to the trigger rule to determine whether the trigger rule is triggered, e.g., the condition of the trigger rule being met.

In step 1108, the agent can perform the action responsive to the condition being met by the information determined in step 1106. The action may cause a physical device to be operated or information be sent to another agent including another trigger rule and another action rule. In some embodiments, the action can be performed by executing the action rule of the agent. The action rule can perform an action based on one or more parameter value of the action rule. In some embodiments, the action output of the action rule can be sent directly to the physical device, e.g., the building subsystems 122. In some embodiments, the action output can be stored into the graph. Another operating component of the building data platform, e.g., a command processor (e.g., the command processor 136), can read the action from the graph can communicate a corresponding command to the building subsystems.

In some embodiments, instead of a digital twin triggering its own action, a trigger of the digital twin can trigger an action of another digital twin. For example, a rules engine of the twin manager 108 (e.g., the rules engine 932 described in FIGS. 9-10) can link multiple triggers and actions of various digital twins together. For example, the rules engine can store a logical rule with conditional requirements, e.g., triggers being tripped of one or more digital twins, Boolean logic and/or operations (e.g., AND, OR, XOR, NAND, NOT, XNOR, NOR, greater than, less than, equals, etc.), etc. The rule can indicate that when conditions of various triggers of various digital twins are satisfied, one or more actions of various digital twins should be executed.

Referring generally to FIGS. 12-23, systems and methods for using artificial intelligence to determine triggers and actions for an agent is shown. The triggers can trigger autonomously based on received data and cause an action to occur. In some embodiments, multiple digital twins can interact with each other by identifying interrelationships between each other via the graph, e.g., a VAV digital twin could interact with an AHU digital twin responsive to identifying that a VAV represented by the VAV digital twin is related to an AHU represented by the AHU digital twin via the graph. The digital twins can in some embodiments, simulate the impact of triggers and/or actions to validate and learn triggers and/or actions.

In some embodiments, the building data platform 100 can perform q-learning (Reinforcement Learning) to train and/or retrain the triggers and/or actions of the agents. In some embodiments, the data used to train and/or retrain the triggers and/or actions can be simulated data determined by another digital twin.

One digital twin may have trigger conditions such as, “when the outside temperature is x₀,” “when the inside humidity is x %,” “when an AI-driven algorithm's threshold is reached,” and “when it is a certain day of the week.” In responsive to one or multiple triggers being met, the digital twin can perform actions (e.g., capabilities of a device either inherent and/or digital twin enhanced). The actions can include setting a setpoint to a value x₀. The actions can be to run a fan for x minutes. The actions can be to start an AI-driven energy saving schedule. The actions can be to change a mode status to an away status. In some embodiments, the building data platform can user other digital twins to simulate a reward for various values of the triggers and/or actions. The reward can be optimized to determine values for the parameters of the triggers and/or actions.

In some embodiments, allowing the digital twin to learn and adjust the parameters of the triggers and/or rules allows the digital twin to optimize responses to internal and/or external events in real-time. In some embodiments, the digital twin performs operations with the correlation of contextual relationships to provide spatial intelligence. In some embodiments, the digital twin allows for AI-based self-learning solutions to operate on top of the digital twin. The digital twin can capture comprehensive data that drives rich analytics for security, compliance, etc. In some embodiments, the digital twin can enable and perform simulations.

In some embodiments, the building data platform 100 can identify events and/or event patterns if the building data platform 100 identifies a pattern that suggests a trigger and/or action should be updated. For example, if the building data platform 100 identifies a pattern occurring in a building, the building data platform 100 can set triggers and/or actions in digital twins to allow the pattern to occur automatically. For example, if a user closes their blinds at 5:00 P.M. regularly on weekdays, this could indicate that the user desires the blinds to be closed at 5:00 P.M. each day. The building data platform 100 can set a blind control digital twin to trigger a blind closing action at 5:00 P.M. each day.

In some embodiments, an agent of a digital twin can predict an inference in the future indicating that some action should be performed in the future. The building data platform 100 can identify that the action should be performed in the future and can set up a flow so that a prediction of one digital twin can be fed into another digital twin that can perform the action.

Referring now to FIG. 12, a system 1200 of a trigger rule 1202 of a thermostat digital twin where parameters of the trigger rule 1202 are trained is shown, according to an exemplary embodiment. In some embodiments, the system 1200 can implement a model that rewards triggers and/or actions of the thermostat digital twin using a neural network that is trained from data aggregated from a related digital twin of the thermostat digital twin, an air handler unit digital twin.

The building data platform 100 can perturb parameters, ε₁ and ε₂ of the trigger rule 1202 of the thermostat digital twin. The trigger rule 1202 may be that if a number of occupants is greater than ε₁ and a zone temperature is less than ε₂° C. the rule is triggered and a corresponding action be performed. The corresponding action can be to increase a supply air temperature setpoint of an AHU to 22° C. The perturbation of the parameters can be increasing or decreasing the parameters in set amounts from existing values. The perturbation of the parameters can be selecting a space of values for the parameters and/or randomizing the parameters and/or parameter space.

With the perturbed values for ε₁ and ε₂, the AHU digital twin 1204 can simulate the state of the AHU via the AHU digital twin 1204 for various conditions of occupant number and zone temperature. The result of the various states of the AHU digital twin 1204. The simulation can be performed by the AI agent 570 via the model 576. The output of the model 576 can be the simulated states, e.g., timeseries 566.

The building data platform 100 can analyze the states produced by the AHU digital twin 1204 to determine energy and comfort results from the states of the AHU digital twin 1204. For example, an energy score can be generated for each state. For example, a power consumption level can be determined for each state. Similarly, a comfort violation score can be determined for each state. The comfort violation can indicate whether or not a temperature, humidity, or other condition of a physical space controlled by the AHU would be uncomfortable for a user (e.g., go below or above certain levels).

The building data platform 100 can generate accumulated training data. The accumulated training data can include the values of the parameters ε₁ and ε₂, the state of the AHU digital twin 1204 for each value of the parameters, and the energy score and comfort violation score for each state. In some embodiments, the triggers and/or actions that can be recommended for the thermostat digital twin can be determined by observing the responses of other digital twins on perturbed thresholds of existing triggers and/or actions.

The building data platform 100 can generate neural networks 1210 for predicting an energy score based on the parameters ε₁ and ε₂. Furthermore, the neural networks 1210 can indicate a comfort violation score for the parameters ε₁ and ε₂. The neural networks 1210 can be trained by the building data platform 100 based on the accumulated training data 1208.

Based on the trained neural network models 1210, the building data platform 100 can determine optimal values for the parameters ε₁ and ε₂. The building data platform 100 can search a space of potential values for ε₁ and ε₂ that consider predicted energy scores and/or comfort violation scores predicted by the trained neural network models 1210. The optimization can be the relation 1400 shown in FIG. 14. The optimization 1212 performed by the building data platform 100 can be a method of computing the optimal threshold of a trigger conditions using the neural network models 1210 of rewards (e.g., energy and comfort) and solving constrained optimization model. Similarly, the optimization 1212 performed by the building data platform 100 to determine the optimal threshold of action commands using the neural network models 1210 of rewards and solving constrained optimization.

In some embodiments, the optimal values for the parameters found by the building data platform 100 can be presented to a user for review and/or approval via a user interface, e.g., via the user device 176. In some embodiments, the recommendations produced by the building data platform 100 through the components 1202-1212 can be restricted by only looking at state/value changes of digital twins that are nearest neighbors in the graph 529, e.g., two nodes are related by one edge, e.g., a thermostat node for the thermostat digital twin is directed to an AHU node for the AHU digital twin 1204. In some embodiments, the building data platform 100 can use spatial correlation to assume contextual relationship between assets that can affect each other's attribute states/values.

Referring now to FIG. 13, a process 1300 for identifying values for the parameters of the trigger rule 1202 of FIG. 12 is shown, according to an exemplary embodiment. The process 1300 can be performed by the building data platform 100 and/or any component of the building data platform 100. The process 1300 can be performed by the system 500 and/or components of the system 500. Furthermore, the process 1300 can be performed by any computing device described herein.

In step 1302, the building data platform 100 can perturb a thermostat digital twin (e.g., the thermostat digital twin rule 1202) with various value for thresholds and/or other parameters, e.g., E. The result of the perturbed parameters can result in various states, s. The states can be states predicted by the thermostat digital twin or another digital twin that operates based on the thresholds and/or parameters ε, e.g., the AHU digital twin 1204. The perturbations and simulated states can result in pairs (S, ε). The pairs can be used to determine feedback for energy and/or comfort, e.g., (E, C).

In step 1304, the building data platform 100 can building neural network models, e.g., the neural networks 1210 based on the data determined in step 1302. The neural networks 1210 can predict energy rewards as a function of the state and the parameters, e.g., E=f(s, ε). Furthermore, the neural networks 1210 can predict comfort rewards as a function of the state and the parameters, e.g., C=f(s, ε).

In step 1306, the building data platform 100 can determine a value for the parameter, E that minimizes a relation, (α₁·E+α₂·C). The minimization is shown in relation 1400 of FIG. 14. The values of α₁ and α₂ can weigh the various rewards in the relation that is minimized, e.g., the energy reward and/or the comfort reward.

In step 1308, the building data platform 100 can periodically repeat the steps 1302-1306. For example, the building data platform 100 can repeat the steps at a defined time period. In some embodiments, the building data platform 100 can compute rewards for the actions of the thermostat digital twin. If the rewards indicate that the thermostat digital twin need retraining, the building data platform 100 can repeat the steps 1302-1308.

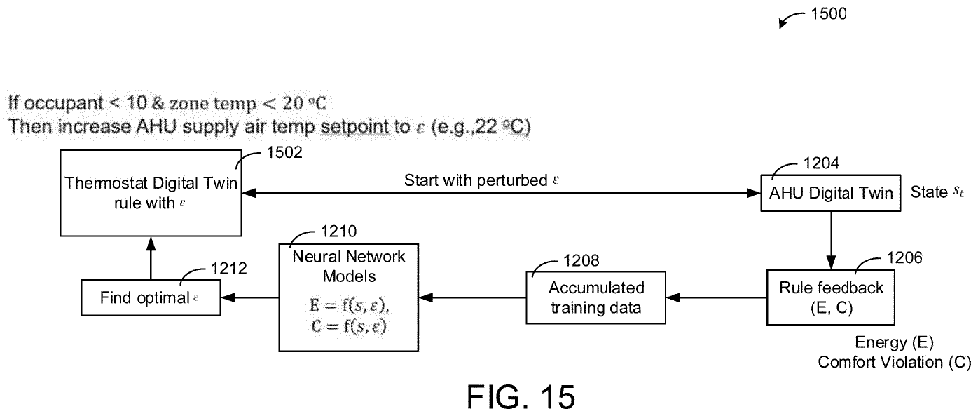

Referring now to FIG. 15, a system 1500 of components where an action rule 1502 of a thermostat digital twin is shown where parameters of the action rule 1502 are trained, according to an exemplary embodiment. The system 1500 can include similar and/or the same components of FIG. 14. The process 1300 of FIG. 13 can be applied to the action rule 1502 to train the parameters of the action rule 1502.

The thermostat digital twin rule 1502 can be an action rule that if a trigger is met (e.g., the trigger 1402), the action rule 1502 executes to command the AHU digital twin 1204. The trigger rule may be to execute the action rule if an occupant count is greater than ten and a zone temperature is less than twenty degrees Celsius. The action rule 1502 may be to increase an AHU supply air temperature setpoint to a value, e.g., ε. In some embodiments, the value can be 22 degrees Celsius.

The building data platform 100 can predict states resulting from perturbed values of E by executing the AHU digital twin 1204 to simulate the states. The building data platform 100 can collect rule feedback 1206 to construct accumulated training data 1208. Furthermore, the building data platform 100 can train neural network models 1210 based on the accumulated training data 1208 and find optimal values for the parameter ε based on the trained neural network models 1210

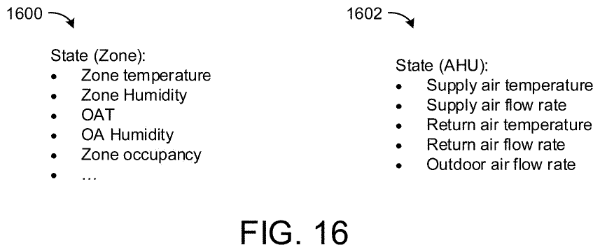

Referring now to FIG. 16, a list 1600 and a list 1602 of states of a zone and of an air handler unit that can be used to train the parameters of the trigger rule and the action rule of the thermostat digital twins of FIGS. 12-15 is shown, according to an exemplary embodiment. The list 1600 includes states for a zone. The states can be zone temperature, zone humidity, outdoor air temperature, outdoor air humidity, zone occupancy, etc. These states can be predicted and/or determined based on a digital twin for a space based on perturbed parameter values for a trigger rule, an action rule, weather forecasts, etc. In some embodiments, the rule feedback 1206 can be generated based on the digital twin for the space and used to tune the values of the parameters for the trigger rule 1402 and/or the action rule 1502.

The list 1602 includes states for an AHU. The states can be supply air temperature, supply air flow rate, return air temperature, return air flow rate, outdoor air flow rate, etc. These states can be predicted and/or determined based on a digital twin for an AHU (e.g., the AHU digital twin 1204) based on perturbed parameter values for a trigger rule, an action rule, etc. In some embodiments, the rule feedback 1206 can be generated based on the digital twin for the AHU and used to tune the values of the parameters for the trigger rule 1402 and/or the action rule 1502.

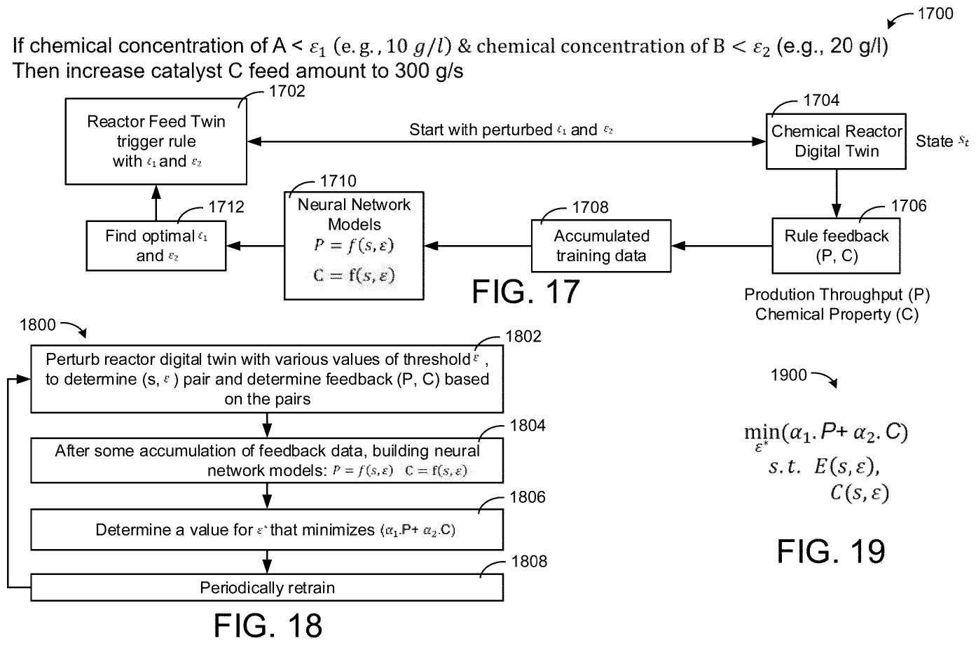

Referring now to FIG. 17, a system 1700 of a trigger rule of a chemical reactor digital twin where parameters of a trigger rule are trained is shown, according to an exemplary embodiment. A reactor feed digital twin which may model the feed of a chemical reactor can include various trigger rules and/or action rules, e.g., the trigger rule 1702. The trigger rule 1702 can be that if a chemical concentration of a first chemical A is less than ε₁ (e.g., 10 g/l) and a chemical concentration of a second chemical B is less than ε₂ (e.g., 20 g/l) then an action rule is triggered. The action rule may be increase a catalyst C feed amount to 300 g/s.

The building data platform 100 can perturb the values for the parameters ε₁ and ε₂ of the reactor feed digital twin trigger rule 1702 (e.g., pseudo-randomly, increasing and/or decreasing in a particular number of predefined increments, etc.). A chemical reactor digital twin 1704 can simulate a state of the chemical reactor for the various perturbed parameters ε₁ and £₂. The building data platform 100 can determine a rule feedback 1706 for the state simulate by the chemical reactor digital twin 1704. The rule feedback 1706 can identify scores for production throughput (P) and chemical property (C).

The building data platform 100 can accumulate training data 1708. The accumulated training data 1708 can include the feedback 1706, the state simulated by the chemical reactor digital twin 1704, and/or the parameter values for ε₁ and ε₂. The building data platform 100 can train neural network models 1710 to predict production throughput and/or chemical property for the various parameter and/or state pairs, e.g., the state resulting from the parameters of the trigger rule 1702. The building data platform 100 can use the trained neural network models 1710 to identify optimal values for ε₁ and ε₂. In element 1712, the building data platform 100 can identify values for ε₁ and ε₂ that minimize the relation 1900 shown in FIG. 19. In some embodiments, the optimization can optimize production throughput and/or chemical property.

Referring now to FIG. 18, a process 1800 for identifying values for the parameters of the trigger rule of FIG. 17 is shown, according to an exemplary embodiment. The process 1800 can be performed by the building data platform 100 and/or any component of the building data platform 100. The process 1900 can be performed by the system 500 and/or components of the system 500. Furthermore, the process 1900 can be performed by any computing device described herein. The steps 1802-1808 can be the same as or similar to the steps 1302-1308. However, the steps 1802-1808 can be executed for a reactor digital twin and the reward for training the neural networks and be production throughput and chemical property.

In step 1802, the building data platform 100 can perturb a reactor digital twin 1704 with various values of a threshold ε of a trigger rule 1702 with various values which cause the reactor digital twin to determine resulting states for the various values of the threshold, E. The states and the values for the threshold ε can create state threshold pairs. The pairs can be used to determine feedback, e.g., production throughput and chemical property.

In step 1804, after some accumulation of feedback data, the building data platform 100 can build neural network models 1710 based on the pairs that predict production throughput and chemical property based on the values for the threshold E. In step 1806, the building data platform 100 can determine a value for the threshold ε that maximizes a reward and/or minimizes a penalty. The building data platform 100 can minimize the relation 1900 of FIG. 19. In step 1808, the building data platform 100 can periodically retrain the values for the threshold ε for the trigger rule 1702.

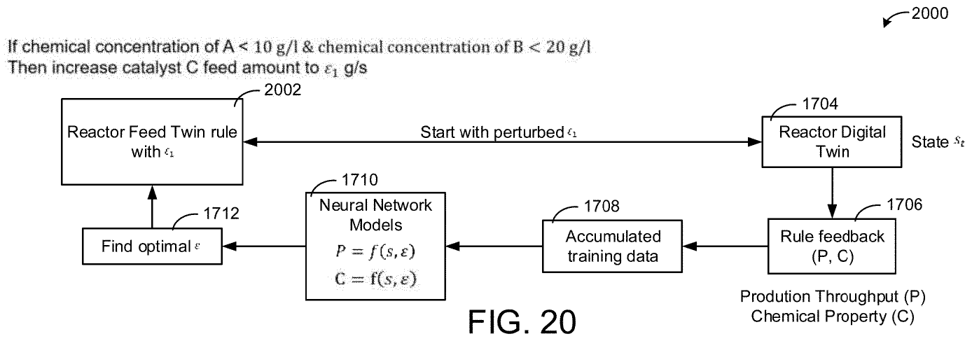

Referring now to FIG. 20, a system 2000 including an action rule 2002 of a chemical reactor digital twin where parameters of the action rule 2002 are trained is shown, according to an exemplary embodiment. The reactor feed twin rule 2002 can be an action rule to increase a catalyst C feed amount to ε₁ g/s in response to an trigger rule being triggered, e.g., the trigger rule 1702. The building data platform 100 can perturb the values of the parameter ε₁ and the reactor digital twin 1704 can predict states resulting from the perturbed parameter. The building data platform 100 can determine rule feedback 1706 and generate accumulated training data 1708 based on the rule feedback 1706. The building data platform 100 can train the neural network models 1710. Based on the neural network models 1710, the building data platform 100 can find optimal values for the parameter ε₁.

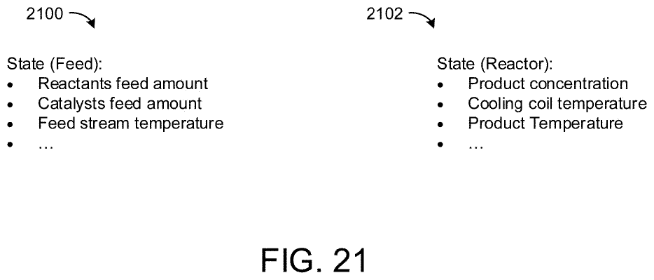

Referring now to FIG. 21, a list 2100 and a list 2102 of states of a feed of a reactor and a reactor that can be included in the trigger rule and the action rule of FIGS. 17-20 are shown, according to an exemplary embodiment. The list 2100 includes states for a feed of a chemical reactor. The states can be reactants feed amount, catalysts feed amount, feed stream temperature, etc. These states can be predicted and/or determined based on a digital twin for a space based on perturbed parameter values for a trigger rule, an action rule, etc. In some embodiments, the rule feedback 1706 can be generated based on the digital twin for the space and used to tune the values of the parameters for the trigger rule 1702 and/or the action rule 2002.

The list 2102 includes states for a chemical reactor. The states can be product concentration, cooling coil temperature, product temperature, etc. These states can be predicted and/or determined based on a digital twin for a chemical reactor (e.g., the reactor digital twin 1704) based on perturbed parameter values for a trigger rule, an action rule, etc. In some embodiments, the rule feedback 1706 can be generated based on the digital twin for the chemical reactor and used to tune the values of the parameters for the trigger rule 1702 and/or the action rule 2002.

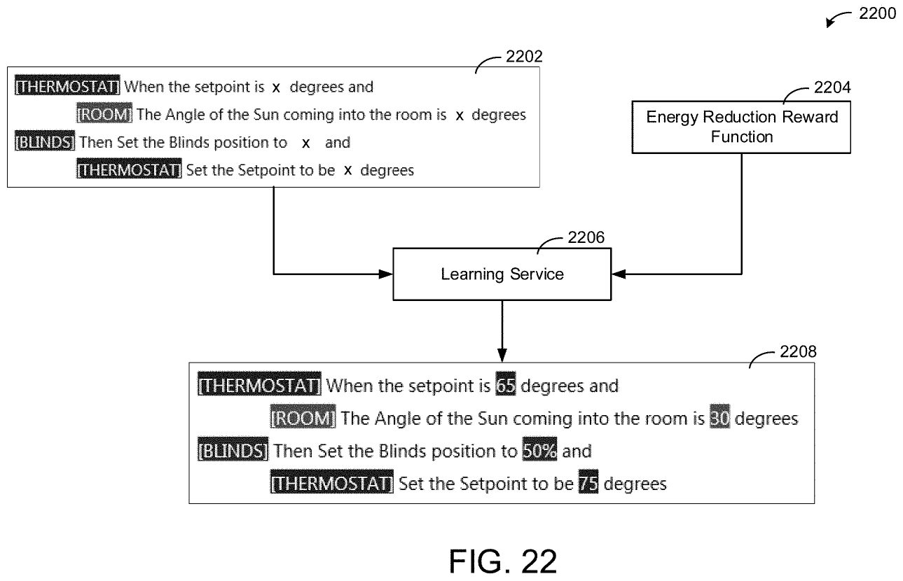

Referring now to FIG. 22, a system 2200 where triggers and actions that can be constructed and learned for a digital twin is shown, according to an exemplary embodiment. Considering a building where a room in the building has a thermostat, the building data platform 100 can construct triggers and/or actions of an agent of a digital twin or the room. The triggers and/or actions can be determined with an energy reduction reward function 2204 by a learning service 2206. The energy reduction reward function 2204 can produce triggers and/or actions that have values that minimize energy usage.

In some embodiments, the building data platform 100 can search the graph 529 to identify information related to the space, e.g., related pieces of equipment, spaces, people, etc. For example, the building data platform 100 can identify which entities of the graph 529 are related and operate to affect each other. The building data platform 100 can identify which actions each entity can perform and/or what measurements each entity can make, e.g., by identifying related data nodes for each entity. The identified entities, measurements, and/or commands can be combined into the rule 2202 by the building data platform 100.

In some embodiments, the learning service 2206, which may be a component of the building data platform 100, can run a learning process with the rule 2202 and/or one or more reward functions (e.g., comfort reward function, carbon footprint reduction reward function, the energy reduction reward function 2204, etc.). The learning service 2206 can learn the rule 2208 from the rule 2202 and/or the energy reduction reward function 2204.

The learning service 2206 can run an optimization to determine combinations between measurements and actions triggered based on the measurements. The learning service 2206 can determine values for each measurement and/or action. Furthermore, the learning service 2206 can identify the relational operations for causing a trigger, e.g., equals to, greater than, less than, not equal to, etc. Furthermore, the learning service 2206 can identify action operations, e.g., increase by a particular amount, decrease by a particular amount, set an output equal to a value, run a particular algorithm, etc.

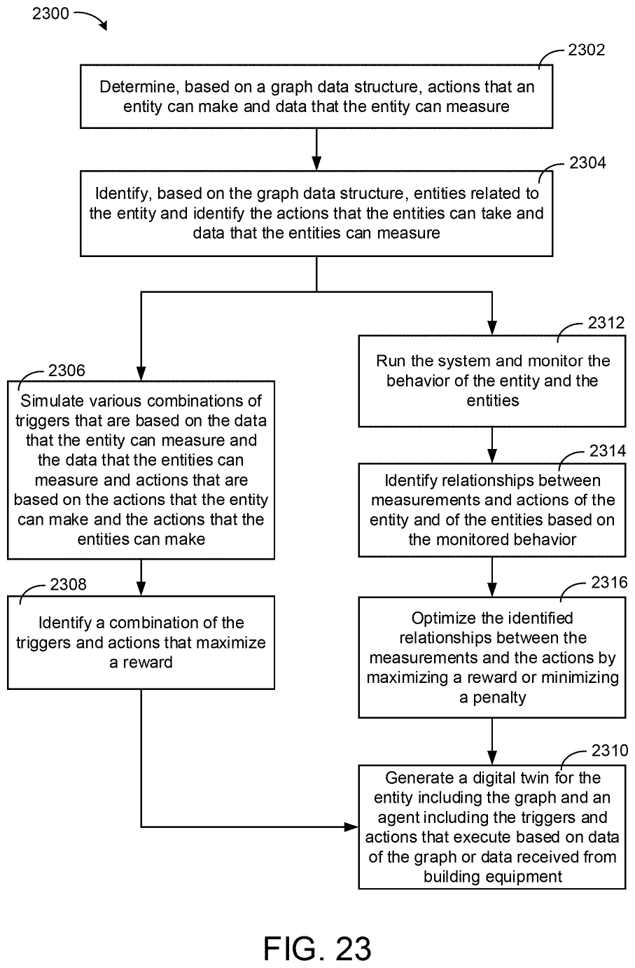

Referring now to FIG. 23, a process 2300 for constructing triggers and actions for a digital twin is shown, according to an exemplary embodiment. In some embodiments, the process 2300 can be performed by a building data platform (e.g., the building data platform 100). In some embodiments, the process 2300 can be performed by a learning service (the learning service 2206).

In step 2302, the building data platform 100 can determine actions that a particular entity can take and data that the entity can measure by analyzing a graph (e.g., graph 529). The entity can be a thermostat, an air handler unit, a zone of a building, a person, a VAV unit, and/or any other entity. For example, if the entity is a thermostat the building data platform could identify room temperature measurements for a thermostat and/or a cooling stage command, a heating stage command, a fan command, etc. that the thermostat can perform. Responsive to identifying data that the entity can measure, the building data platform can generate a trigger condition based on the data type, e.g., when the temperature is equal to, less than, greater than, and/or not equal to some parameter value, trigger an action.

In step 2304, the building data platform can identify, based on the graph, entities related to the entity and actions that the entities can take and data that the entities can measure. For example, if the entity is for a thermostat for a zone, the building data platform could identify a shade control system for controlling a shade of the zone, an air handler unit that serves the zone, a VAV that serves the zone, etc. For example, the building data platform can identify, based on the building graph, that a blinds node is associated with a zone node that the thermostat node is related to. The building data platform can identify a list of actions that the entities can perform, e.g., setting blind position from 0% (fully open) to 100% (fully closed).

In some 2306, the building data platform can simulate various combinations of triggers that tare based on the data that the entity and/or entities can measure and actions that are based on the actions that the entity and/or entities can make. The building data platform can simulate various combinations, trigger operations, action operations, and/or parameters.

In step 2308, the building data platform can identify a combination of triggers and actions that maximizes a reward. The building data platform can search the simulated combinations of triggers and/or actions to identify a trigger and/or action that maximizes a reward and/or minimizes a reward. In some embodiments, the building data platform uses a policy gradient and value function instead of brute force to try out combinations of the triggers and/or actions in the steps 2306-2308.

In some embodiments, the building data platform can identify the operations for the triggers and/or actions. For example, the operation could be comparing a measurement to a threshold, determining whether a measurement is less than a threshold, determining whether a measurement is greater than the threshold, determining whether the measurement is not equal to the threshold, etc.

In step 2310, the building data platform can generate a digital twin for the entity. The entity can include (or reference) the graph and include an agent that operates the triggers and/or actions. The triggers and/or actions can operate based on the graph and/or based on data received building equipment, e.g., the building subsystems 122.

In step 2312, the building data platform can run a building system of a building and monitor the behavior of the entity and entities of the building. In some embodiments, the building system can include the building subsystems 122.

In step 2314, the building data platform can identify relationships between the measurements and actions of the entity and/or the entities based on the monitored behavior. The building data platform can discover existing relationships by identifying how the measurements are currently affecting actions based on the monitored behavior. In step 2316, the building data platform can optimize the identified relationships between the measurements and the actions by maximizing a reward or minimizing a penalty.

Autonomous FDD Rule Threshold Tuning with Digital Twins

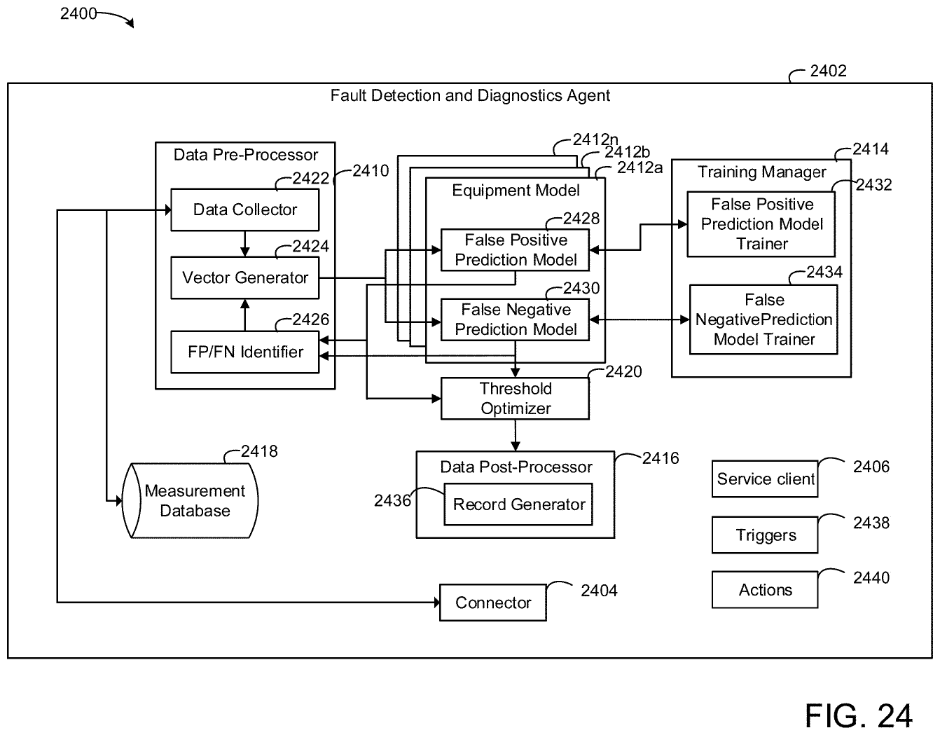

Referring generally to FIGS. 24-29, a building system, e.g., the system 500, can include a fault detection and diagnostics (FDD) agent. The FDD agent can be a type of AI agent 570 or include one or more AI agents 570. In some embodiments, the FDD agent can be a digital twin of an FDD subsystem of a building. The FDD agent can be configured to provide continuous fault detection for digital twins of the building subsystems 122 and/or building subsystem devices (i.e., building equipment). The FDD agent can include one or mode models (e.g., model 576) that may be used to predict satisfaction/violation of fault rules and tune thresholds for fault rules. The trigger rule (e.g., trigger rules 597) may include the fault rules. Accordingly, when the fault rule is satisfied, the FDD agent may determine that a fault has been detected. The FDD agent can be configured to determine a resolution for fixing the fault. The FDD agent can be configured to ingest the fault back into the graph. For example, an indicator and/or link to the resolution can be added to an existing node of the building graph and/or a new node can be created with the indicator and/or the link to the resolution. In some embodiments, the FDD agent can identify an existing node representing a piece of equipment and ingest the resolution into another node related to the node representing a piece of equipment by an edge. In some embodiments, if the node representing the resolution does not exist in the graph, the FDD agent can cause create a new node of the building graph to represent the resolution.

The FDD agent can receive data inputs from a connector (e.g., the connector 574), an AI model storage (e.g., AI model storage 568), AI service client (e.g., AI service client 588), etc. The FDD agent can automatically diagnose and respond to detected faults. The responses to detected and/or diagnosed faults can include providing an alarm message to a user, providing the detected and/or diagnostic faults to a maintenance scheduling system to cause maintenance to be scheduled, and/or providing the detected and/or diagnosed faults to a control algorithm configured to repair the fault or to work-around the fault by operating building equipment. In some embodiments, the FDD may include triggers and/or actions. The triggers and/or actions are to the triggers and/or actions as described with reference to the AI agent 570. For example, the triggers may be stored as nodes in the graph 529 and/or may include rules (e.g., conditions) that upon satisfaction may indicate a fault. Further, the actions may be stored as nodes in the graph 529 and/or include the generation of an output that indicates a fault was detected. Other actions may include shutting down a sub-system, controlling activities of the faulty devices/sub-systems, alerting users of the faults, generating work orders to fix the fault, etc.

The FDD agent can be configured to output a specific identification of the faulty component or cause of the fault (e.g., loose damper linkage) using detailed subsystem inputs available via the connector from the graph (e.g., graph 529). In some embodiments, The FDD agent is configured to provide fault events to the graph 529 which executes control strategies and policies in response to the received fault events. According to an exemplary embodiment, The FDD agent can shut-down systems and/or direct control activities around faulty devices and/or systems to reduce energy waste, extend equipment life, and/or assure proper control response within the graph.

The FDD agent can be configured to store or access a variety of different system data stores (or data points for live data). The FDD agent can use some content of the data stores to identify faults at the equipment level (e.g., specific chiller, specific AHU, specific terminal unit, etc.) and other content to identify faults at component or subsystem levels. For example, building subsystems 122 can generate temporal (i.e., time-series) data indicating the performance of BAS 400 and the various components thereof. The data generated by building subsystems 122 can include measured and/or calculated values that exhibit statistical characteristics and provide information about how the corresponding system or process (e.g., a temperature control process, a flow control process, etc.) is performing in terms of error from its setpoint. These processes can be examined by The FDD agent to expose when the system begins to degrade in performance and alarm a user to repair the fault before it becomes more severe.

Referring now to FIG. 24, a block diagram of a system 2400 including a fault detection and diagnostics (FDD) agent 2402 that is configured to predict false positives and false negatives of faults in a building management system (e.g., system 100) is shown, according to an exemplary embodiment. The FDD agent 2402 may include or be connected to one or more AI agents (e.g., AI agent 570). The FDD agent 2402 may include a connector 2404 that may receive information from the graph (e.g., graph 529) or output information to the graph. The FDD agent 2402 may also include a service client 2406 that causes an instance of the FDD agent 2402 to run and communicate with the other components of the building data platform 100. The FDD agent 2402 may operate in a cloud environment or locally by a processor at the building management system. The FDD agent 2402 may implement one or more machine learning models to predict false positives and false negatives of faults that are detected in the building equipment. The FDD agent 2402 may do so by inputting measurements of various points of the piece of building equipment into the machine learning models and determining whether individual output confidence scores for false positives and false negatives from the models satisfy a predetermined criteria (e.g., exceed a predetermined threshold, is the highest predicted confidence score, etc.).

The FDD agent 2402 can include triggers 2438 and actions 2440. The triggers 2438 can include fault rules that, when met, cause one or more of the actions 2440. The triggers 2438 can be executed based on information stored in the graph 529 and/or data received from the building subsystems 122. The actions 2440 can be executed to determine commands, actions, and/or outputs. The output of the actions 2440 can be stored in the graph 529 and/or communicated to the building subsystems 122.

According to various example implementations of the present disclosure, the FDD agent 2402 may determine that a building equipment has a fault based on the trigger or satisfaction of a rule. A false positive may indicate that the building equipment actually is not experiencing a fault, and the rule incorrectly determined that a fault has occurred. Furthermore, the FDD agent 2402 may determine that a building equipment is not experiencing a fault because a state of the building did not satisfy the rule. A false negative may indicate that the building equipment is actually experiencing a fault, and the rule incorrectly determined that the fault did not occur. Although the false positive prediction model 2428 is described in detail herein, similar description may apply for the false negative prediction model 2430 except for false negatives instead of false positives.

As used herein, “points” or “data points” refer to sensor inputs, control outputs, control values, and/or different characteristics of the inputs and/or outputs. “Points” and/or “data points” may refer to various data objects relating to the inputs and the outputs such as BACnet objects. The objects may represent and/or include a point and/or group of points. The object may include various properties for each of the points. For example, an analog input may be a particular point represented by an object with one or more properties describing the analog input and another property describing the sampling rate of the analog input. For example, in some embodiments, a point is a data representation associated with a component of a BMS, such as a camera, thermostat, controller, VAV box, RTU, valve, damper, chiller, boiler, AHU, supply fan, etc.

System 2400 may include the FDD agent 2402. In some embodiments, FDD agent 2402 operates in the cloud as one or more cloud servers. The FDD agent 2402 may communicate over a network (e.g., a synchronous or asynchronous network) via the connector 2404.

FDD agent 2402 may include a data pre-processor 2410, equipment models 2412a-n, a training manager 2414, a data post-processor 2416, and a measurement database 2418.

In some embodiments, data pre-processor 2410 includes a data collector 2422, a vector generator 2424, and an FP/FN identifier 2426. Data collector 2422 may be configured to collect data that corresponds to different digital twins of the building equipment. Data collector 2422 can be configured to retrieve and/or collect building data from the graph via the connector 2404 and store the building data in measurement database 2418, in some embodiments. In some embodiments, the data collector 2422 can be configured to collect data automatically or poll sensors associated with building equipment to collect data at predetermined time intervals set by an administrator. In some embodiments, data collector 2422 can further be configured to collect data upon detecting that a value changed by an amount exceeding a threshold. In some embodiments, data collector 2422 is configured to collect building data upon receiving a request from an administrator. The administrator may make the request from a client device. The administrator can request building data associated with any time period and building device.

In some embodiments, the data collector 2422 may execute fault rules related to the building equipment and determine whether any fault rules have been satisfied. For example, a fault rule pertaining to the AHU may state that if the air supply temperature is less than a first threshold and if the fan speed is greater than a second threshold, the AHU has a fault. Accordingly, the data collector 2422 may collect the measurements (e.g., air supply temperature and fan speed) from the measurement database 2418 and determine whether any fault rule is satisfied such that a fault is determined to exist for the AHU. Then, the data collector 2422 may provide the measurements, the thresholds, and/or the determination of whether there is a fault to the vector generator 2424 so that a vector may be generated for the prediction models.

Data collector 2422 may be configured to tag each data point of the data with timestamps indicating when the data point was generated and/or when data collector 2422 collected the data point from the sensors. In some embodiments, data collector 2422 can also tag the data with a device identifier tag indicating the building device from which the building data was collected. Thus, data collector 2422 may store the timestamped data in measurement database 2418 as a timeseries corresponding to how the measured values changed over time.

As described herein, timeseries can be a collection of values for a particular point (e.g., a discharge air temperature point of an air handling unit, a discharge air temperature, a supply fan status, a zone air temperature, a humidity, a pressure, etc.) generated at different times (e.g., at periodic intervals) by the building equipment and/or the data pre-processor 2410 (e.g., timeseries 564, timeseries 566). The timeseries data may be retrieved via the connector 2404. The values of the timeseries may include or be associated with identifiers of the building devices with which the points are associated (e.g., an air handler, a VAV box, a controller, a chiller, a boiler, vents, dampers, etc.). Each timeseries can include a series of values for the same point and a timestamp for each of the data values. For example, a timeseries for a point provided by a temperature sensor (e.g., provided through local gateways) can include a series of temperature values measured by the temperature sensor and the corresponding times at which the temperature values were measured. An example of a timeseries which can be generated by data collector 2422 is as follows:
[<key, timestamp1, value1>, <key, timestamp2, value2>, <key, timestamp3, value3>]
   where key is an identifier of the source of the raw data samples (e.g., timeseries ID, sensor ID, device ID, etc.), timestampi may identify the time at which the ith sample was collected, and valuei may indicate the value of the ith sample.

Measurement database 2418 may be a database configured to store building data associated with a building data platform (e.g., building data platform 100). Measurement database 2418 can be a graph database, MySQL, Oracle, Microsoft SQL, PostgreSql, DB2, document store, search engine, device identifier-value store, etc. Measurement database 2418 can be configured to hold data including any amount of values and can be made up of any number of components. The data can include various measurements and states (e.g., temperature readings, pressure readings, device state readings, blade speeds, etc.) associated with building equipment (e.g., AHUs, chillers, boilers, VAVs, fans, etc.) of the building management system. In some embodiments, the building data is tagged with timestamps indicating times and dates that the values of the building data were generated by devices (e.g., sensors) of the building management system or retrieved by data collector 2422.

In some embodiments, measurement database 2418 may store setpoint values for different points of the building management system. The stored setpoint values may be associated with a schedule indicating the times in which building equipment will operate so points of the building managements system will reach the corresponding stored setpoints. For example, a setpoint schedule may indicate that a kitchen should be 70 degrees at 7 P.M. but 68 degrees at 3 P.M. Accordingly, a controller (e.g., controller in the building subsystems 122) may control the building equipment of the building to cause the temperature point to reach the setpoint temperature at the corresponding times. Measurement database 2418 may include schedules for setpoints of any point of the building to reach a desired level of comfort for the building's occupants.

Vector generator 2424 may be configured to generate a feature vector that is configured to be input into machine learning models of equipment models 2412a-n from measurement database 2418. For example, the feature vector may include a state of the building equipment and a threshold that is used in the fault rule. For example, for an AHU of the building, there may be a fault rule that states if supply air temperature is less than a certain temperature and the fan speed is greater than a certain rotation per minute (RPM), there is a fault with the AHU. This may fault rule may be expressed as follows:
if(c₁<ε₁ & ε₂>ε₂),
then AHU has fault F₁
   where c₁ corresponds to the supply air temperature, ε₁ corresponds to a first threshold, c₂ corresponds to the fan speed, ε₂ corresponds to a second threshold, and F₁ corresponds to the fault ID. For a first machine learning model, the state of the AHU may include the supply air temperature and the first threshold, and for a second machine learning model, the state of the AHU may include the fan speed and the second threshold. These pairs may be provided as feature vectors to the respective machine learning models.

Vector generator 2424 may generate such feature vectors upon determining an event has occurred. An event may be or include a detection that a value associated with the piece of building equipment is above a threshold, a determination that a predetermined time interval has passed since vector generator 2424 previously executed the machine learning model, receipt of a user input indicating to execute the machine learning model, receipt of a signal from another computing device indicating to execute the machine learning model, etc. Vector generator 2424 may monitor various aspects of the building management system to identify such events and determine when the events occur. For example, vector generator 2424 may keep track of the times in which vector generator 2424 executes the machine learning model. Vector generator 2424 may maintain an internal clock and identify when a predetermined (e.g., a pre-programmed) time period has passed since the last time vector generator 2424 executed the machine learning model and determine the predetermined time period has passed. Vector generator 2424 may identify an event as occurring upon determining the predetermined time period has passed.

Upon determining an event has occurred, vector generator 2424 may generate a feature vector. Vector generator 2424 may generate the feature vector by identifying the piece of building equipment that is associated with the event (e.g., the piece of building equipment that has a stored association with the event) and retrieve data that corresponds to the piece of building equipment. Vector generator 2424 may retrieve the data that is associated with attributes or points of the piece of building equipment based on a stored association between the values and the attributes or points. Vector generator 2424 may retrieve data that is associated with values from within a pre-configured time frame of the event (e.g., values that are associated with timestamps from a time frame before and/or after the event) and generate a feature vector using the retrieved values. Vector generator 2424 may retrieve values that were collected from sensors of the building and/or values of setpoints that are stored in memory (e.g., measurement database 2418).

Upon generating the feature vector, vector generator 2424 may identify the machine learning model that is associated with the piece of building equipment that is associated with the event. The vector generator 2424 may identify the machine learning model from equipment models 2412a-n that each includes or is otherwise associated with a different false positive prediction model 2428 and/or a false negative prediction model 2430. Each of equipment models 2412a-n may be a data representation of a different piece of building equipment within the building management system. The false positive prediction models and/or false negative prediction models of each equipment model 2412a-n may be associated with a device identifier of the respective equipment model 2412a-n. The vector generator 2424 may identify, responsive to determining the identified event, false positive prediction model 2428 and false negative prediction model 2430 are associated with the same or an identical device identifier. Upon identifying the false positive prediction model 2428, the vector generator 2424 may apply the generated feature vector to the false positive prediction model 2428 and execute the false positive prediction model 2428.

The false positive prediction model 2428 may be a machine learning model (e.g., a neural network, a random forest, a support vector machine, etc.) configured to output confidence scores associated with a whether the satisfaction of a fault rule (e.g., determination that the building equipment has a fault) related to a building equipment was a false positive. The false positive prediction model 2428 may be configured to output confidence scores for fault determinations based on feature vectors that are generated by vector generator 2424 based on data that corresponds to a particular piece of building equipment (e.g., the piece of building equipment that the equipment model represents). The false positive prediction model 2428 may output confidence scores for whether the determination that a fault has occurred in the building equipment is a false positive. The FP/FN identifier 2426 may identify the confidence scores and/or determine whether the determination of a fault in the piece of building equipment is a false positive in the future based on the confidence scores.

The FP/FN identifier 2426 may be configured to use a predetermined criteria to determine if and/or when a fault is likely to occur in a piece of building equipment. The predetermined criteria may be a threshold and/or one or more fault rules. For instance, the FP/FN identifier 2426 may determine a fault determination is a false positive by comparing the confidence score to a predetermined threshold. Responsive to determining the score exceeds the threshold, the FP/FN identifier 2426 may determine that the fault determination (e.g., the fact that there was a fault in the building equipment) is a false positive. However, responsive to determining the score does not exceed the threshold, the data processing system may determine that the fault determination is not likely a false positive (e.g., the fault is actually a true positive). The data processing system may compare the confidence score to any fault rule or threshold.

Upon determining a confidence score for a fault rule satisfied the predetermined criteria, the FP/FN identifier 2426 may identify the fault rule that was determined to have been satisfied and associated with the confidence score and an identification of the threshold in the fault rule that was used to determine the fault. In some embodiments, the FP/FN identifier 2426 may generate an alert indicating the fault did not occur in the building equipment and transmit the alert to a client device (e.g., an administrative device) so an administrator can view the alert and keep the building equipment operation/online. In some embodiments, the FP/FN identifier 2426 may feed the identification of the false positive back to the vector generator 2424, which in turn can use the identification to generate a new feature vector.

The false negative prediction model 2430 may be a machine learning model similar to false positive prediction model 2428. The false negative prediction model 2430 is configured to predict when false negatives occurred, in some embodiments. The false negative prediction model 2430 may be configured to output confidence scores for fault determinations based on feature vectors that are generated by the vector generator 2424 based on data that corresponds to a particular piece of building equipment (e.g., the piece of building equipment that the equipment model represents). The false positive prediction model 2428 may output confidence scores for false positives and false negatives indicating likelihoods that the individual false positives and false negatives are the correct prediction.

The threshold optimizer 2420 may receive the output confidence scores and process the scores to optimize the threshold that was used to determine the faults in the fault rules that were used in the false positive prediction model 2428 and the false negative prediction model 2430. The threshold optimizer 2420 may use constrained nonlinear optimization to find the optimal threshold value (based on the accumulated data so far) that minimizes the number of false positives and false negatives.

The data post-processor 2416 may receive the output confidence scores and the optimal threshold values and process the scores and thresholds to transmit a signal to the user device 176 and/or controller in the building subsystems 122 to adjust the threshold of the fault rules. The data post-processor 2416 includes instructions performed by one or more servers or processors, in some embodiments. In some embodiments, the data post-processor 2416 includes a record generator 2436. The record generator 2436 may receive the predicted confidence scores and/or optimal threshold value and generate a record (e.g., a file, document, table, listing, message, notification, etc.) including confidence scores and/or the threshold values. Upon generating the record, the record generator 2436 may transmit the record to user device 176 for display and/or controller in the building subsystems 122 to use to adjust operation or the configuration of building equipment to avoid the false positive and false negative in the fault rule.

The FDD agent 2402 can provide indications of recommendations of how to adjust the threshold values to the user device 176 and/or controller in the building subsystems 122. In some embodiments, controller in the building subsystems 122 uses the expected recommendations to operate building equipment (e.g., control environmental conditions of a building, cause generators to turn on or off, charge or discharge batteries, etc.). Further, the user device 176 can receive the indications and/or recommendations and cause a client device to display indications (e.g., graphical elements, charts, words, numbers, etc.) of the threshold values and/or recommendations. For example, user device 176 may receive the fault rule and the optimal threshold value so that the user can modify the fault rule in the FDD agent 2402.

In some embodiments, the FDD agent 2402 trains the prediction models of the equipment models 2412a-n using training manager 2414. The training manager 2414 includes instructions performed by one or more servers or processors, in some embodiments. In some embodiments, the training manager 2414 includes a false positive prediction model trainer 2432 and/or a false negative prediction model trainer 2434. The false positive prediction model trainer 2432 may be configured to train the false positive prediction model 2428 and other false positive prediction models of the equipment models 2412a-n to predict when false positives occur when a fault is detected for pieces of building equipment. The false positive prediction model trainer 2432 may feed labeled training data including measurements associated with points of a particular piece of building equipment to the false positive prediction model associated with the piece of building equipment. The respective false positive prediction model may output confidence scores for thresholds and the false positive prediction model trainer 2432 may determine differences between the predicted outputs and the labels and use back-propagation techniques according to a loss function to adjust the false positive prediction model's weights and parameters proportional to the determined differences. The false positive prediction model trainer 2432 may repeat these steps for any number of fault prediction machine learning models to train the machine learning models to predict future false positives for individual pieces of building equipment.

Similarly, the false negative prediction model trainer 2434 may be configured to train the false negative prediction model 2430 and other false negative prediction models of the equipment models 2412a-n. The false negative prediction model trainer 2434 may feed measurement data and/or identifications of false negatives to obtain confidence scores for the threshold in fault rules used in determining faults in the building equipment. The false negative prediction model trainer 2434 may identify labels indicating the correct output, determine differences between the correct output and the output of the respective false negative prediction model, and use back-propagation techniques according to a loss function to adjust the weights of the false negative prediction models and parameters according to the determined differences. False negative prediction model trainer 2434 may repeat these steps for any number of false negative prediction models to the machine learning models to predict false negatives for individual pieces of building equipment. In some embodiments, false negative prediction model trainer 2434 may train a false negative prediction model in real-time. In such embodiments, false negative prediction model trainer 2434 may feed measurement data and/or identifications of false negatives into a false negative prediction model to obtain confidence scores for false negatives in a fault rule.

A user may input levels of accuracy (e.g., correct, incorrect, partially correct, etc.) of the recommendations and/or the predicted false positives or false negatives. False positive prediction model trainer 2432 or false negative prediction model trainer 2434 may identify the input levels of accuracy, determine differences between the predicted confidence scores and the input levels of accuracy, and use back-propagation techniques with the false negative prediction model that predicted the confidence scores for the false positives and false negatives according to a loss function based on the differences. Thus, false negative prediction model trainer 2434 may train false negative prediction models in real-time or near real-time, in some embodiments.

In some embodiments, the training manager 2414 may operate in a cloud server and be configured to use training data from multiple building management systems to train false positive prediction models and/or false negative prediction models. The training manager 2414 may be configured to train individual machine learning models using training data that is associated with multiple pieces of building equipment (e.g., building equipment of the same type) until the machine learning models are accurate to a threshold, and then deploy the machine learning models to the local building management system to be used to make predictions for individual pieces of building equipment (and be further trained based only on data associated with the piece of building equipment). This may be advantageous in building management systems that do not have enough training data to train machine learning models to make accurate predictions.

In such embodiments, the training manager 2414 may be configured to train the machine learning models using a weighting policy. The weight policy may include weights that can be applied to different training data sets. The weights may correspond to different building management systems and may be determined based on how trustworthy an administrator has determined data from a building management system to be and/or based on whether the data originated at a building management system for which the models are being trained. The training manager 2414 may use the weights by weighting the differences in a loss function so that training data that is associated with higher weights cause higher shifts in the weights or parameters of a machine learning model than training data that is associated with lower weights during training. Thus, the training manager 2414 may control the training to improve the accuracy and speed with which machine learning models are trained to be employed at individual building management systems.

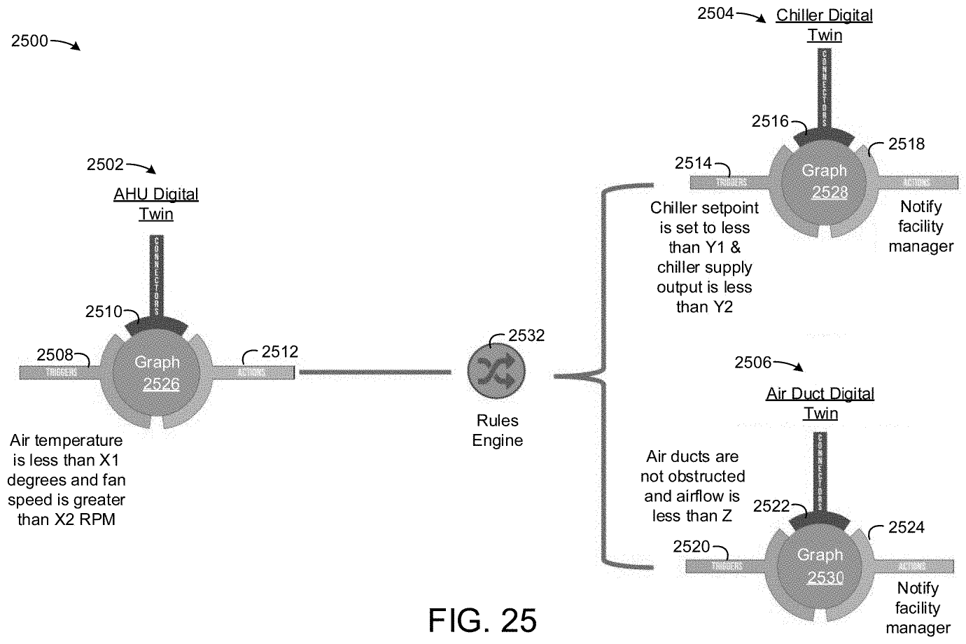

Referring now to FIG. 25, a system 2500 of digital twins including an AHU digital twin 2502, a chiller digital twin 2504, and an air duct digital twin 2506 that are interconnected is shown, according to an exemplary embodiment. In FIG. 25, the AHU digital twin 2502 includes triggers 2508, connectors 2510, actions, and/or the graph 2526. The chiller digital twin 2504 that includes triggers, connectors 2516, actions 2518, and/or the graph 2528. The air duct digital twin 2506 includes triggers, connectors 2522, actions 2524, and/or the graph 2530. In some embodiments, the graph 2526, the graph 2528, and the graph 2530 are the same graph or different graphs. In some embodiments, the graphs 2526-2530 are the graph 529. The triggers 2508, 2516, and 2522 may include fault rules that indicate whether any faults have been detected within the AHU digital twin 2502, chiller digital twin 2504, or air duct digital twin 2506, respectively. In some embodiments, each of the digital twin 2502, 2504, and 2506 can include or has a corresponding FDD agent that manages the FDD operations of the respective digital twin. In some embodiments, there may be one FDD agent that manages the FDD operations of all of the digital twins or some grouping of digital twins.

The AHU digital twin 2502 can output an indication that a fault has been detected, indications to control the AHU, etc. which can be stored in the graph 2526 and/or provided to the chiller digital twin 2504 and/or the air duct digital twin 2506. In some embodiments, if all of the digital twins use and/or have access to the same graph, and if the AHU digital twin 2502 stores the fault indicator in the graph, the chiller digital twin 2504 and the air duct digital twin 2506 can read the attribute from the graph. In some embodiments, a rules engine 2532 can store rules that link the digital twins 2502, 2504, and 2506 together. The rules engine 2532 can be included in the twin manager 108, and the rules of the rules engine 2532 can be stored in the entity, relationship, and event database 160 or other database. The rules engine 2532 can determine whether the triggers of the various digital twins are triggered, e.g., the trigger 2508. Furthermore, the rules engine 2532 can determine (based on one or more rules stored by the rules engine 2532) that if the trigger 2508 of the AHU digital twin 2502 is triggered, the actions 2518 of the chiller digital twin 2504 and the actions 2524 of the air duct digital twin 2506 should be executed.

In some embodiments, the trigger 2508 is the logical condition, “air temperature is less than X1 degrees and fan speed is greater than X2 RPM.” If the air temperature is less than a first threshold (e.g., X1 degrees) and the fan speed is greater than a second threshold (e.g., X2 RPM), a fault may be detected in the AHU digital twin 2502. The AHU digital twin 2502 can determine from models and/or information of the graph 2526 (e.g., the rules in the graph 2526) that a fault has been detected and the trigger 2508 has been triggered.

Responsive to the trigger 2508 being triggered, the rules engine 2532 can cause the actions 2512 to execute to output a series of outputs such as an indication that a fault in the AHU has been detected, the rule(s) that satisfied the fault, the threshold(s) that were used within the rule(s), and the state(s) of the AHU that were used in the rule(s) for the determination of the fault. These outputs can be stored in the graph 2526 and/or communicated to a chiller sub-system and the air duct sub-system to execute on. Then the action 2518 may be executed. For example, the action 2518 may be to that set the chiller supply setpoint to be less than Y1 and the chiller output supply setpoint to be less than Y2 if the rule (or trigger 2508) is satisfied. In some embodiments, the action 2518 may be an output such as an indication that a fault in the chiller has been detected, the rule(s) that satisfied the fault, the threshold(s) that were used within the rule(s), and the state(s) of the chiller that were used in the rule(s) for the determination of the fault. Furthermore, the rules engine 2532 can cause the trigger 2520 to be executed. The trigger 2520 may be related to the air duct digital twin 2506 and cause an action 2524 to be executed which include opening the air ducts and setting the air flow setpoint to be less than Z. In some embodiments, the action 2524 may be an output such as an indication that a fault in the air ducts has been detected, the rule(s) that satisfied the fault, the threshold(s) that were used within the rule(s), and the state(s) of the air duct that were used in the rule(s) for the determination of the fault.

In some embodiments, when the trigger 2508 is triggered, the rules engine 2532 can cause a trigger 2514 to be analyzed responsive to the trigger 2508 being triggered. The trigger 2514 may be related to the chiller digital twin 2504. When the trigger 2514 is triggered, the action 2518 may be executed.

In some embodiments, the digital twins of the system 2500 can be solution digital twins, e.g., the AHU digital twin 2502, the chiller digital twin 2504, the air duct digital twin 2506, etc. The digital twin can be a solution digital twin because it represents particular software solutions for the building. For example, in some embodiments, a thermostat digital twin can be triggered with turn-off function or display an error code (e.g., the triggering of the AHU digital twin 2502 shown in FIG. 25). The AHU digital twin 2502 could be configured to identify what AHU is serving the zone that it has made an occupancy detection for based on the nodes and/or edges of the graph 2526 relating a zone node for the zone and an AHU node for the AHU. In some embodiments, the AHU digital twin can evaluate the desired setting for the zone through running a simulation with one or more models.

Accordingly, a hierarchy or an association of rules may be used within the FDD agent of the digital twins. Furthermore, although not described, various rules that are associated with one another may have corresponding digital twins that are used by the FDD agent.

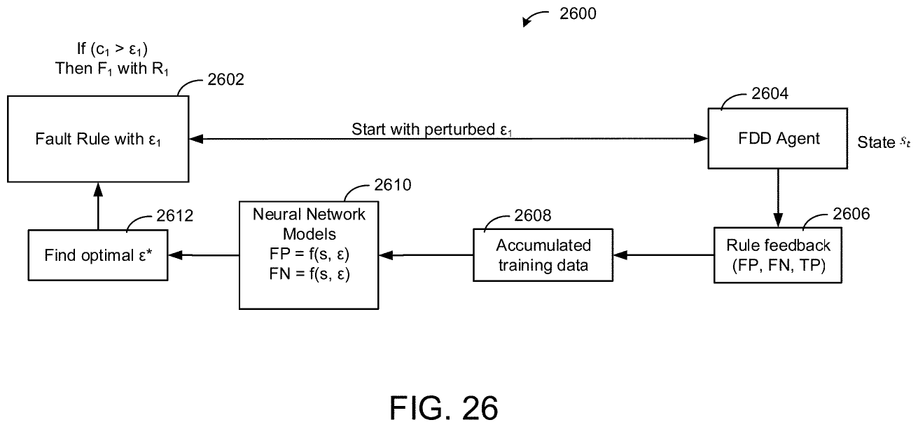

Referring now to FIG. 26, a system 2600 shows thresholds of a fault rule (or trigger rule) 2602 being trained, according to an exemplary embodiment. The process block diagram 2600 may be implemented by the system 2400 and/or components of the building data platform 100 as described above. In the example described in FIG. 26 below, a rule for an AHU is described for the sake of clarity and brevity, but embodiments are not limited thereto, and the disclosed technology may be implemented for a variety of other building equipment and/or fault rules. For example, the building equipment may be related to fire safety, lifts/escalators, electrical, ICT, security, HVAC, lighting or any other building equipment within or around buildings. Further, the fault rules may be related to any fault rule that is implemented within the FDD agent. In some embodiments, the process block diagram 2600 can implement a model that rewards triggers and/or actions of the AHU digital twin using a neural network that is trained from data aggregated from a related digital twin of the AHU digital twin.

The building data platform 100 can perturb parameter ε₁ of the fault rule 2602. For example, the trigger fault rule 2602 may include a fault rule that if supply air temperature is less than ε₁° C., the fault rule is triggered (or satisfied), and a corresponding action be performed. The corresponding action can be a determination that a fault exists with the AHU. The perturbation of the parameters can be increasing or decreasing the parameters in set amounts from existing values. The perturbation of the parameters can be selecting a space of values for the parameters and/or randomizing the parameters and/or parameter space.

With the perturbed values for ε₁, the FDD agent 2604 can simulate the state of the AHU for various temperatures within a range. The simulation can be performed by the FDD agent of the FDD agent 2604 via the models 2412a-2412n. The output of the models 2412a-2412n can be a determination of false positive or false negative.

The building data platform 100 can analyze the states produced by the FDD agent 2604 to determine states of the AHU digital twin. For example, the air supply temperature and fan speed can be generated and collected for each state. Furthermore, the state can be any metric that is collected from any portion of the AHU digital twin. For example, the state can include supply air temperature, fan speed, AHU operating mode (heating, cooling with outdoor air, etc.), outside air temperature, zone temperature, zone humidity, etc. Once the state is collected, various fault rules may be calculated related to the AHU digital twin to determine whether a fault exists.

The building data platform 100 can receive feedback 2606 from a user on whether the fault that was computed is a false positive, false negative, or true positive. As discussed above, false positive can imply that although a fault rule was satisfied to determine that a fault existed, there is no fault. False negatives can imply that although the fault rule was not satisfied, and therefore no fault was detected, the AHU digital twin in fact does have a fault. And a true positive can imply that the fault that was detected is true and no adjustment needs to be made to the fault rule.

The building data platform 100 can generate accumulated training data 2608. The accumulated training data can include the values of the parameter ε₁, the state of the AHU digital twin for each value of the parameters, and the labeled data including whether the fault determination was a false positive, false negative, or true positive. In some embodiments, the triggers and/or actions that can be recommended for the AHU digital twin can be determined by observing the responses of other digital twins on perturbed thresholds of existing triggers and/or actions.

The building data platform 100 can generate neural networks 2610 for predicting whether the fault determination was a false positive or a false negative based on the state s and parameter ε. Furthermore, the neural networks 1210 can indicate a threshold violation score for the parameter ε. The neural networks 2610 can be trained by the system 2600 based on the accumulated training data 2608.

The building data platform 100 can then determine an optimal value for the parameter ε. The system 2600 can search a space of potential values for E that consider false positives and false negatives predicted by the trained neural network models 2610. The optimization can be the relation 2800 shown in FIG. 28. The optimization 2612 performed by the building data platform 100 can be a method of computing the optimal threshold of a trigger condition using the neural network models 2610 of rewards and solving a constrained nonlinear optimization model. In some embodiments, the optimal values for the parameters found by the system 2600 can be presented to a user for review and/or approval via a user interface, e.g., via the user device 176.

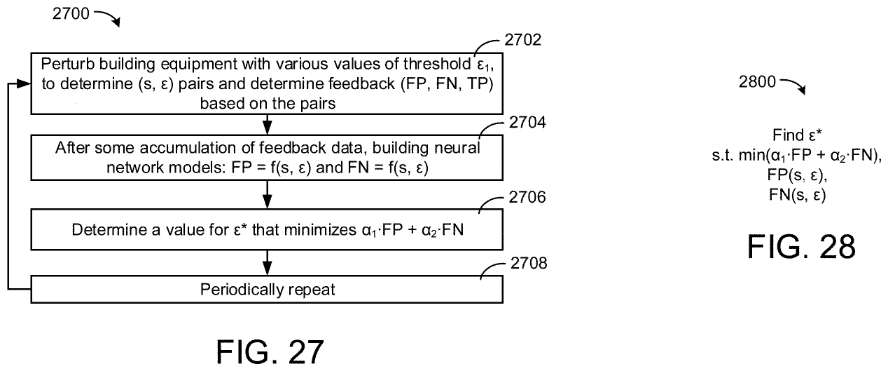

Referring now to FIG. 27, a process 2700 for identifying values for the parameters of the trigger fault rule 2602 of FIG. 26 is shown, according to an exemplary embodiment. The process 2700 can be performed by the building data platform 100 and/or any component of the building data platform 100. Furthermore, the process 2700 can be performed by any computing device described herein.

In step 2702, the building data platform 100 can perturb an AHU digital twin (e.g., fault rule 2602) with various values for thresholds E. The result of the perturbed parameters can result in various states, s. The states can be states predicted by the AHU digital twin or another digital twin based on the threshold and/or parameters as described herein. The perturbations can result in pairs (s, ε) that can be used to determine feedback for false positive, false negative, or true positive.

In step 2704, the building data platform 100 can accumulate the pairs and corresponding feedback to create neural network models, e.g., the neural networks 2610 based on the data determined in step 2702. The neural networks 2610 can predict false positive and false negative rewards as a function of the state and the threshold, e.g., FP=f(s,ε) and FN=f(s,ε).

In step 2706, the building data platform 100 can determine a value for the parameter, E that minimizes a relation, (α₁·FP+α₂·FN). The minimization is shown in relation 2800 of FIG. 28. The values of α₁ and α₂ can weigh the various rewards in the relation that is minimized, e.g., the false positive and false negative reward.

In step 2708, the building data platform 100 can periodically repeat the steps 2702-2706. For example, the building data platform 100 can repeat the steps at a defined time period (e.g., every day, week, month, etc.). In some embodiments, the retraining may occur if the rate of false positives and/or the rate of false negatives exceed an acceptable range set by the user. For example, if the user set the acceptable false positive rate to be 10% or lower, and the neural network model for false positives had a rate of 15%, the model may be retrained.

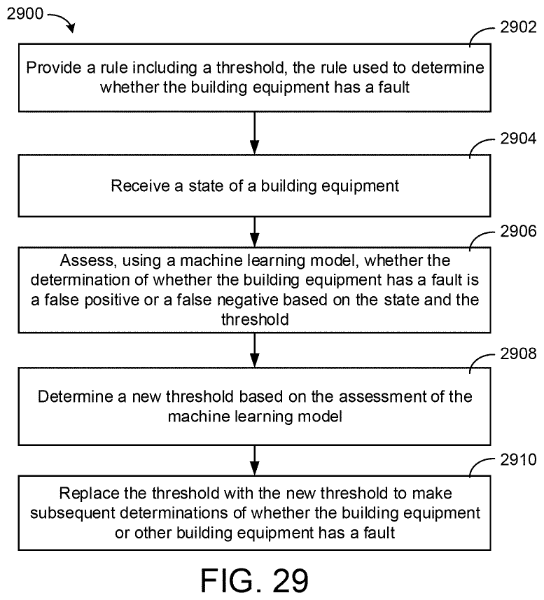

Referring now to FIG. 29, a process 2900 of determining the optimal threshold for a fault rule (e.g., building equipment fault rule, trigger fault rule, or fault rule) is shown, according to an exemplary embodiment. The process 2900 can be performed by the system 400, 500, 600, and/or any of their components or a combination of their components. The process 2900 can be performed by any computing device or processing circuit described herein. Furthermore, the process 2900 may be include additional steps or certain steps may be removed depending on embodiments.

In step 2902, the system can provide a fault rule including a threshold. The fault rule can pertain to any rule that is used by the FDD agent to determine whether a fault exists within the building equipment or not. For example, if there is a fault rule that states if AHU mode is mechanical cooling with 100% outdoor air and the magnitude of the difference between outside air temperature and mixed air temperature is greater than a threshold, the AHU is faulty.

In step 2904, the system can receive a state of the building equipment. In some embodiments, the state can include any or all values that are used to calculate whether a fault rule is satisfied or not. In the above example, the AHU running in a mode with mechanical cooling with 100% outdoor air, the outside air temperature, and mixed air temperature can all be part of the state of the AHU. Further, the threshold can be the value that is being optimized so that the system can reduce or minimize the number of false positives and false negatives.

In step 2906, the system can assess, using a machine learning model, whether the determination of whether the building equipment has fault is a false positive or a false negative based on the state and the threshold. For example, if the above fault rule was satisfied, the system may determine that a fault exists in the AHU. However, in reality, the AHU may be operating normally and not have a fault as determined by occupants of the building or the building manager. Accordingly, the administrator of the model may provide feedback to the system indicating that the fault is a false positive. In another example, the fault rule may not be satisfied and the system may then determine that the AHU does not have a fault. However, based on occupant or building manager feedback, it may be determined that the AHU is actually faulty, and the administrator may provide feedback to the system that there was a false negative.

In step 2908, the system may determine a new threshold based on the assessment of the machine learning model. This may be done using constrained nonlinear optimization that solves for the minimal number of false positives and false negatives based on the feedback received in step 2906. The new threshold may be higher or lower than the existing one, depending on the parameters set with the optimization equations. Further, the user may desire to reduce the number of false positives more than the false negatives, in which case the optimization parameters used in the equations may be adjust so that greater weight is given to minimizing the false positives. In other embodiments, the user may be interested in reducing the false negatives more than the false positives, in which case greater weight can be given to reducing the false negatives more than the false positives. In step 2910, the system may replace the threshold with the new threshold to make subsequent determinations of whether the building equipment or other building equipment has a fault. The number of false positives and false negatives may be reduced and/or minimized.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed:

1. A building system of a building, the building system comprising:
one or more storage media having instructions stored thereon that, when executed by one or more processors, cause the one or more processors to:
store a digital twin on the one or more storage media, the digital twin including one or more fault detection or diagnostics functions and a virtual representation of a piece of equipment, the virtual representation including one or more entities of a building and relationships between the entities of the building, wherein the one or more fault detection or diagnostic functions operate on the virtual representation of the piece of equipment to perform fault detection or diagnostics;
execute the digital twin based on the virtual representation of the piece of building equipment to generate an indication of a fault or a diagnosis of the fault for the one or more pieces of building equipment; and
store an indication of the fault or a diagnosis of the fault, or a link to the fault or the diagnosis of the fault, in the virtual representation of the piece of equipment.

2. The building system of claim 1, wherein the virtual representation of the one or more pieces of building equipment includes a building graph comprising a plurality of nodes representing a plurality of entities of the building and a plurality of edges between the plurality of nodes representing relationships between the plurality of entities of the building.

3. The building system of claim 2, wherein the one or more fault detection or diagnostics functions include a fault rule including a threshold, wherein the threshold being met indicates the fault or a diagnosis for the fault.

4. The building system of claim 3, wherein the instructions further cause the one or more processors to:
receive a state of the building equipment;
assess, using a machine learning model, whether the determination of whether the building equipment has the fault is a false positive or a false negative based on the state and the threshold;
determine a new threshold based on the assessment of the machine learning model; and
replace the threshold with the new threshold to make subsequent determinations of whether the building equipment or other building equipment has a fault.

5. The building system of claim 4, wherein the new threshold reduces a number of false positives a number of false negatives.

6. The building system of claim 4, wherein the instructions further cause the one or more processors to accumulate training data for the machine learning model using the state and the threshold as inputs and labels of false positive or false negative as outputs.

7. The building system of claim 4, wherein the fault rule includes:
a condition portion including a comparison of the state to the threshold; and
an action portion including a determination that the building equipment is faulty when the condition is satisfied or not faulty when the condition is not satisfied.

8. The building system of claim 4, wherein the instructions further cause the one or more processors to perturb the building equipment with multiple values of the threshold to provide additional data for the machine learning model.

9. The building system of claim 4, wherein the machine learning model includes a first machine learning model for predicting a false negative and a second machine learning model for predicting a false positive.

10. The building system of claim 9, wherein the first machine learning model is configured to accurately predict false positives at different values of state and threshold, and wherein the instructions further cause the one or more processors to retrain the first machine learning model.

11. The building system of claim 9, wherein the second machine learning model is configured predict false negatives at different values of state and threshold, and wherein the instructions further cause the one or more processors to retrain the second machine learning model.

12. The building system of claim 1, wherein the instructions further cause the one or more processors to receive an indication to:
receive an indication that a fault has been detected in the digital twin; and
execute a second digital twin, the second digital twin including one or more fault detection or diagnostics functions and a second virtual representation of a second piece of equipment, the second virtual representation including one or more second entities of a building and relationships between at least one of the second entities of the building and at least one of the entities of the building,
wherein the one or more fault detection or diagnostic functions of the second digital twin operate on the second virtual representation of the piece of equipment to perform fault detection or diagnostics based on a determination of the fault detected in the digital twin.

13. The building system of claim 1, wherein the instructions further cause the one or more processors to receive an indication to:
execute a fault detection and diagnostics (FDD) agent including one or more machine learning models for determining a new threshold in a fault rule for determining whether the building equipment has a fault; and
providing training data to the machine learning model, wherein the training data includes a plurality of states and a plurality of thresholds of the fault rule as inputs and feedbacks of false positive and false negative of the fault rule as outputs.

14. A method comprising:
receiving, by a processing circuit, an indication to execute a digital twin, the digital twin including one or more fault detection or diagnostics functions and a virtual representation of a piece of equipment, the virtual representation including one or more entities of a building and relationships between the entities of the building, wherein the one or more fault detection or diagnostic functions operate on the virtual representation of the piece of equipment to perform fault detection or diagnostics;
executing, by the processing circuit, the digital twin based on the virtual representation of the piece of building equipment to generate an indication of a fault or a diagnosis of the fault for the one or more pieces of building equipment; and
storing, by the processing circuit, an indication of the fault or a diagnosis of the fault, or a link to the fault or the diagnosis of the fault, in the virtual representation of the piece of equipment.

15. The method of claim 14, wherein the virtual representation of the one or more pieces of building equipment includes a building graph comprising a plurality of nodes representing a plurality of entities of the building and a plurality of edges between the plurality of nodes representing relationships between the plurality of entities of the building, and
wherein the one or more fault detection or diagnostics functions include a fault rule including a threshold, wherein the threshold being met indicates the fault or a diagnosis for the fault.

16. The method of claim 15, wherein the instructions further cause the one or more processors to:
receiving, by the processing circuit, a state of the building equipment;
assessing, by the processing circuit using a machine learning model, whether the determination of whether the building equipment has the fault is a false positive or a false negative based on the state and the threshold;
determining, by the processing circuit, a new threshold based on the assessment of the machine learning model; and
replacing, by the processing circuit, the threshold with the new threshold to make subsequent determinations of whether the building equipment or other building equipment has a fault.

17. The method of claim 16, further comprising accumulating, by the processing circuit, training data for the machine learning model using the state and the threshold as inputs and labels of false positive or false negative as outputs, wherein the new threshold reduces a number of false positives a number of false negatives.

18. A non-transitory computer-readable storage medium having instructions stored thereon that, when executed by one or more processors, cause the one or more processors to:
receive an indication to execute a digital twin, the digital twin including one or more fault detection or diagnostics functions and a virtual representation of a piece of equipment, the virtual representation including one or more entities of a building and relationships between the entities of the building, wherein the one or more fault detection or diagnostic functions operate on the virtual representation of the piece of equipment to perform fault detection or diagnostics;
execute the digital twin based on the virtual representation of the piece of building equipment to generate an indication of a fault or a diagnosis of the fault for the one or more pieces of building equipment; and
store an indication of the fault or a diagnosis of the fault, or a link to the fault or the diagnosis of the fault, in the virtual representation of the piece of equipment.

19. The non-transitory computer-readable storage medium of claim 18, wherein the virtual representation of the one or more pieces of building equipment includes a building graph comprising a plurality of nodes representing a plurality of entities of the building and a plurality of edges between the plurality of nodes representing relationships between the plurality of entities of the building, and
wherein the one or more fault detection or diagnostics functions include a fault rule including a threshold, wherein the threshold being met indicates the fault or a diagnosis for the fault.

20. The non-transitory computer-readable storage medium of claim 19, wherein the instructions further cause the one or more processors to:
receive a state of the building equipment;
assess, using a machine learning model, whether the determination of whether the building equipment has the fault is a false positive or a false negative based on the state and the threshold;
determine a new threshold based on the assessment of the machine learning model; and
replace the threshold with the new threshold to make subsequent determinations of whether the building equipment or other building equipment has a fault.
